(19) United States
(12) Patent Application Publication
(10) Pub. No.: US 2021/0241236 A1
(43) Pub. Date: Aug. 5, 2021

(54) INFORMATION PRESENTATION METHOD, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Yasuto ISHIBASHI, Kanagawa (JP)

(73) Assignee: FUJI XEROX CO., LTD., Tokyo (JP)

(21) Appl. No.: 17/015,083

(22) Filed: Sep. 9, 2020

(30) Foreign Application Priority Data
Feb. 3, 2020 (JP) 2020-016608

(51) Int. Cl. G06Q 10/10; G06Q 30/02; G06Q 10/04; G06Q 50/00; G01C 21/20; G06F 3/0484

(52) U.S. Cl. CPC G06Q 10/1095; G06Q 30/0205; G06Q 10/047; G06Q 50/265; G01C 21/20; G06F 3/0484; G06Q 50/01

(57) ABSTRACT

An information presentation method is executed by a processor of an information processing apparatus, the information processing apparatus providing a service, the service presenting plural target persons who satisfy a criterion with a meeting place to meet at. The information presentation method includes acquiring information, the information being related to plural reference points designated by the plural target persons, determining a meeting place from at least one location, the at least one location being a location whose distances from the plural reference points designated by the plural target persons are all greater than or equal to the corresponding predetermined thresholds, and presenting the determined meeting place to each target person.

### CROSS-REFERENCE TO RELATED APPLICATIONS

This application is based on and claims priority under 35 USC 119 from Japanese Patent Application No. 2020-016608 filed Feb. 3, 2020.

### BACKGROUND

### (i) Technical Field

The present disclosure relates to an information presentation method, an information processing apparatus, and a non-transitory computer readable medium.

### (ii) Related Art

There exist services that, in response to a user of such services setting a convenient date and time for himself or herself, automatically extract a qualifying person who satisfies certain criteria, and present both persons with a place to meet at (see, for example, Japanese Unexamined Patent Application Publication No. 2005-195519).

The provider of such a service manages information such as each user's place of residence, and automatically determines a convenient place for both persons to meet at. There is thus a possibility that the halfway point between both person's places of residence or other such locations may be selected as the meeting place. Although the provider of the service lets neither of these persons who arrange to meet know the other person's place of residence or other such location, this does not preclude the possibility that the determined meeting place may be too close to the places of residence of both persons or other such locations. If the meeting place is too close to both person's places of residence or other such locations, there is a possibility that these persons may, on their way home from a meeting place, find out where each other's homes are.

However, for instance, there may be cases where one does not want his or her home known to someone he or she has just met for the first time. In other cases, unfortunately, one may find the other person he or she has met incompatible. One does not want his or her home to be known, especially to someone with whom he or she is incompatible. There thus exists a need for a system that determines a meeting place while also taking into account cases where the meeting does not go well.

### SUMMARY

Aspects of non-limiting embodiments of the present disclosure relate to reducing the possibility that a reference point designated by each of target persons who arrange to meet may become known to another target person, in comparison to cases where the halfway point between reference points set by individual target persons is determined to be a meeting place at all times.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information presentation method executed by a processor of an information processing apparatus, the information processing apparatus providing a service, the service presenting plural target persons who satisfy a criterion with a meeting place to meet at. The information presentation method includes acquiring information, the information being related to plural reference points designated by the plural target persons, determining a meeting place from at least one location, the at least one location being a location whose distances from the plural reference points designated by the plural target persons are all greater than or equal to the corresponding predetermined thresholds, and presenting the determined meeting place to each target person.

### BRIEF DESCRIPTION OF THE DRAWINGS

Exemplary embodiments of the present disclosure will be described in detail based on the following figures, wherein:

FIG. 1 illustrates an exemplary configuration of a cloud system used in Exemplary Embodiment 1;

FIG. 2 illustrates an exemplary structure of data used in a member database used in Exemplary Embodiment 1;

FIGS. 3A and 3B each explain an exemplary screen displayed on the terminal of a member who wishes to arrange to meet a qualifying person, of which FIG. 3A explains an exemplary screen for selecting a qualifying person, and FIG. 3B explains an exemplary screen for confirming a person whom the member arranges to meet;

FIG. 4 is a flowchart explaining a portion of processing executed in Exemplary Embodiment 1 to determine a meeting place;

FIG. 5 is a flowchart explaining another portion of processing executed in Exemplary Embodiment 1 to determine a meeting place;

FIGS. 6A and 6B each illustrate an exemplary screen for entering a condition used in determining a meeting place, of which FIG. 6A illustrates an initial screen, and FIG. 6B illustrates a state in which one's home has been selected as a reference place;

FIGS. 7A and 7B each illustrate an exemplary screen displayed at the point when the selection of a place used as a reference point has been made, of which FIG. 7A illustrates a state in which the selection of a place has been made, and FIG. 7B illustrates a screen used to set how to determine a meeting place;

FIGS. 8A and 8B each illustrate an exemplary screen used to set the distance between a reference place and a meeting place, of which FIG. 8A illustrates a state in which the choice of wanting to keep a reference place unknown has been selected, and FIG. 8B illustrates a screen used to set a distance;

FIGS. 9A and 9B each illustrate an exemplary screen displayed after a desired distance between one's home and a meeting place is set, of which FIG. 9A illustrates a screen used to confirm selections made, and FIG. 9B illustrates a screen used to check the confirmed information;

FIG. 10 explains an exemplary screen presented to a member who has finished setting how to determine a meeting place, when the other person has not finished the setting yet;

FIGS. 11A and 11B each illustrate an exemplary screen displayed in response to a workplace being selected as the second reference place, of which FIG. 11A illustrates a screen used to confirm selections made, and FIG. 11B illustrates a screen used to check the confirmed information;

FIGS. 12A and 12B each illustrate an exemplary screen displayed if one does not particularly care about the distance between a reference point place and a meeting place, of which FIG. 12A illustrates a state in which the choice of not caring about the distance between a reference point and a meeting place has been selected, and FIG. 12B illustrates a screen displayed after the selection;

FIG. 13 explains an exemplary screen displayed if the setting regarding the distance between a reference place and a meeting place is “I do not particularly care”;

FIG. 14 explains an example in which distances that suit the characteristics of a geographical region are presented as choices;

FIG. 15 illustrates the relationship between a halfway point HP, and thresholds THA and THB for a case where an affirmative result is obtained at each of steps 4 and 5;

FIG. 16 explains an exemplary screen presented to each member if an affirmative result is obtained at each of steps 4 and 5;

FIG. 17 explains an example of how candidate appointment places CAP1 and CAP2 are determined;

FIG. 18 explains an example of how to determine an appointment place AP;

FIG. 19 is a flowchart explaining a portion of processing executed in Exemplary Embodiment 2 to determine a meeting place;

FIG. 20 is a flowchart explaining another portion of processing executed in Exemplary Embodiment 2 to determine a meeting place;

FIG. 21 explains an example of how a centroid point CP is determined if there are five persons who arrange to meet;

FIG. 22 is a flowchart illustrating exemplary processing executed at step 26;

FIG. 23 illustrates an example of candidate appointment places CAP_N that have remained without being removed at step 27;

FIG. 24 explains an example of how a reference candidate RAP is determined;

FIG. 25 explains a specific example of how to determine an appointment place AP;

FIG. 26 is a flowchart illustrating exemplary processing executed at step 26A;

FIG. 27 explains a polygon generated at step 265;

FIG. 28 explains a case where each of members who arrange to meet designates plural places as reference points;

FIG. 29 explains a case where a place that allows for a greater number of available routes than other places is determined to be an appointment place AP; and

FIG. 30 explains a case where a place that allows for a shorter distance of path overlap with another target person than other places is determined to be an appointment place AP.

### DETAILED DESCRIPTION

Exemplary embodiments of the present disclosure will be described below with reference to the drawings.

### Exemplary Embodiment 1

A service according to Exemplary Embodiment 1 (to be also referred to as “the present service” hereinafter) is provided as a membership-based service. Hereinafter, a user of the present service will be referred to as member. A member according to Exemplary Embodiment 1 is a natural person. A member is an example of a target person.

The present service introduces a member to another qualifying member who satisfies certain criteria. In Exemplary Embodiment 1, the member and the other member mentioned above are each assumed to be one person. In other words, the present service is provided with two qualifying members as a unit.

In Exemplary Embodiment 1, each member sets his or her own criteria. However, some of the criteria may be set by the provider of the present service or by a system used to provide the present service. Examples of such criteria set by the service provider or the system include information obtained by learning, as teacher data, the results on past meetings that have been realized. For example, this learning may be performed with all of the members as a unit, with each individual member as a unit, or with members having common attributes as a unit.

The system in this case includes a server or other computational resources. The system includes a single or plural computational resources.

The present service presents, to two members who have decided to arrange to meet, a suitable meeting place for the two members to meet at.

### System Configuration

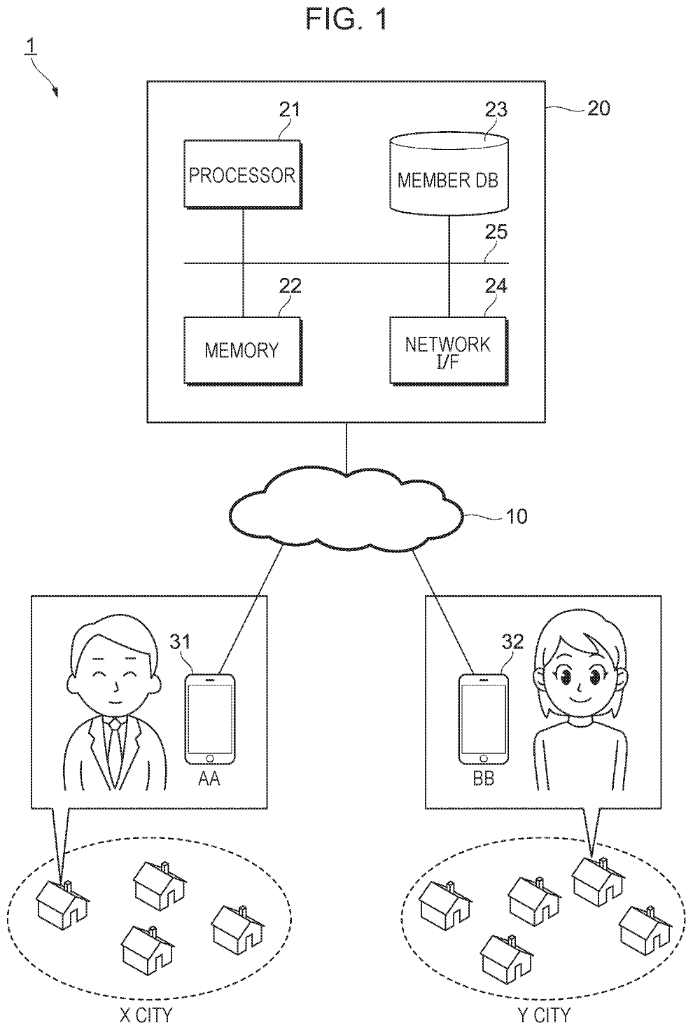

FIG. 1 illustrates an exemplary configuration of a cloud system 1 used in Exemplary Embodiment 1. The cloud system 1 is an example of an information presentation system.

The cloud system 1 includes a cloud network 10, a cloud server 20 that provides the present service, a terminal 31 operated by a member AA, and a terminal 32 operated by a member BB.

In Exemplary Embodiment 1, AA's home is located in an X city, and BB's home is located in a Y city. In the case of FIG. 1, AA is male, and BB is female. The example in FIG. 1 assumes a service that mediates meeting between persons of the opposite gender. However, the present service may be also used to, for example, introduce a member to another member of the opposite gender with common hobbies or interests, or to another member of the opposite gender with a common purpose.

Each of the terminals 31 and 32 in FIG. 1 may be any terminal capable of communicating with the cloud network 10. Examples of such terminals include smartphones, notebook computers, and tablet computers.

The cloud server 20 includes a processor 21, a memory 22, a member database (to be also referred to as “member DB” hereinafter) 23, a network interface (IF) 24, and a bus or other signal line 25. The processor 21 provides the present service through execution of a program. The memory 22 stores a program or other various data. The member database 23 stores information related to each member. The network IF 24 allows for communication with the external environment. The bus or other signal line 25 connects the above-mentioned components of the cloud server 20. Although FIG. 1 depicts a single cloud server 20, plural cloud servers 20 connected to the cloud network 10 may work cooperatively to provide the service. The cloud server 20 in this case is an example of an information processing apparatus.

The processor 21 is implemented as, for example, a central processing unit (CPU). The memory 22 includes, for example, a read only memory (ROM) that stores the basic input output system (BIOS) or other information, a random access memory (RAM) used as a work area, and a hard disk device that stores the basic program, an application program, or other information. The processor 21 and the memory 22 in this case constitute a computer.

The network IF 24 communicates with the cloud network 10. Examples of the network IF 24 to be used include an Ethernet (registered trademark) local area network (LAN) module, a wireless LAN module, a 4G module, and a 5G module.

The member database 23 is, for example, a hard disk device that stores information related to each member of the present service. However, the member database 23 may be implemented as a part of the memory 22. Alternatively, the member database 23 may be implemented as a single or plural storage servers connected to the cloud network 10. In Exemplary Embodiment 1, the member database 23 is distinguished from the memory 22.

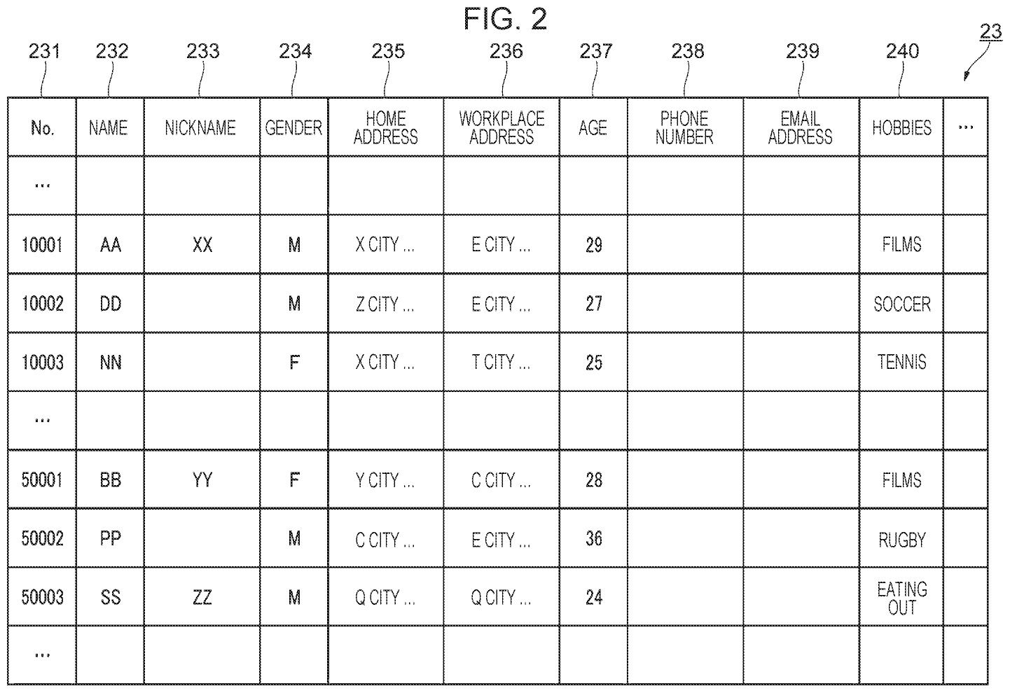

FIG. 2 illustrates an exemplary structure of data used in the member database 23 used in Exemplary Embodiment 1.

The member database 23 stores information registered by each member. The data structure illustrated in FIG. 2 constitutes a part of the member database 23. Examples of other data about each member stored in the member database 23 include a facial image, the date of birth, the member's own annual income, the member's own educational background, a preference for a facility to be used as a meeting place, and the criteria for a desired match.

In the case of the member database 23 illustrated in FIG. 2, information about each member is managed by the following items: management code 231, name 232, nickname 233, gender 234, home address 235, workplace address 236, age 237, phone number 238, email address 239, and hobbies 240.

For example, AA is assigned “10001” as the management code 231. AA's nickname 233 is XX, and AA's gender 234 is male. AA's home address 235 is “X city . . . ”, and AA's workplace address 236 is “E city . . . ”. AA's age 237 is 29, and AA's hobbies 240 include films. For AA, the descriptions of the phone number 238 and the email address 239 are omitted.

BB is assigned “50001” as the management code 231. BB's nickname 233 is YY, and BB's gender 234 is female. BB's home address 235 is “Y city . . . ”, and BB's workplace address is “C city . . . ”. BB's age 237 is 28, and BB's hobbies 240 include films. For BB as well, the descriptions of the phone number 238 and the email address 239 are omitted.

In Exemplary Embodiment 1, among the items of information stored in the member database 23, the nickname 233, the age 237, the hobbies 240, and a facial image are permitted to be disclosed to other members. Other items of information are used for the purpose of providing a service, and not disclosed to other members. However, if a member individually sets an item of information as information to be disclosed, the information is disclosed to the other person.

As the age 237, other than the age at the time of registration, the age at the current time calculated from the date of birth is stored. The age at the current time may be stored separately from the age at the time of registration.

As the phone number 238, one or both of one's home's phone number and mobile phone number are stored.

As the email address 239, one or more addresses are stored. The phone number 238 and the email address 239 represent an example of contacts.

As the hobbies 240, not only one but also plural hobbies can be stored. As the hobbies 240, one or plural items selected from plural items prepared in advance are stored.

### Exemplary Processing Employed for Determination and Presentation of Meeting Place

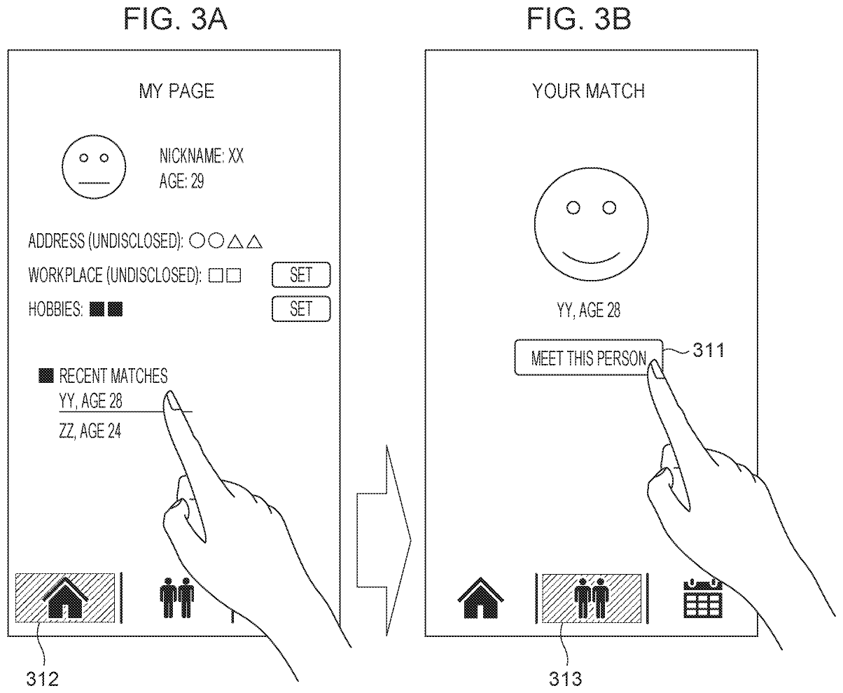

With reference to FIGS. 3A to 18, the following describes an example of processing executed by the cloud server 20 (see FIG. 1).

FIGS. 3A and 3B each explain an exemplary screen displayed on the terminal of a member who wishes to arrange to meet a qualifying person. FIG. 3A illustrates an exemplary screen for selecting a qualifying person, and FIG. 3B illustrates an exemplary screen for confirming a person whom the member arranges to meet.

The screen illustrated in FIG. 3A is the initial screen displayed on the terminal 31 (see FIG. 1) operated by AA. Thus, the screen has the title “My Page”. The Nickname field on My Page shows “XX” previously registered by AA.

In the case of FIGS. 3A and 3B, the “Recent matches” field shows candidates of persons who wish to arrange to meet AA. In Exemplary Embodiment 1, there are two such candidate persons, YY (nickname) and ZZ (nickname).

The “Recent matches” field presents, for example, information about two persons who have provided notification of their wish to actually meet XX (nickname) to the cloud server 20 (see FIG. 1). Thus, if there is no person who has provided notification of the wish to meet to the cloud server 20, the “Recent matches” field is blank. In an alternative implementation, the “Recent matches” field may show persons recommended by the processor 21. In that case, however, it is necessary to make an adjustment such as, after AA designates a person whom AA wants to meet, checking the person whether the person wants to meet AA.

In the case of FIGS. 3A and 3B, the fact that the currently displayed screen is My Page is indicated not only by the title of the screen but also by the highlighted sate of a house-shaped icon 312 located at the bottom of the screen.

Tapping the “YY, age 28” button on the screen illustrated in FIG. 3A with the fingertip displays the screen illustrated in FIG. 3B on the terminal 31.

On the screen illustrated in FIG. 3B, the title has switched to “Your match”. Further, the house-shaped icon 312 at the bottom of the screen changes to a grayed-out state, and an icon 313 representing a couple switches to a highlighted state.

The screen illustrated in FIG. 3B displays a facial image, nickname, and age of YY selected by AA. A tap on the “Meet this person” button 311 on this screen by AA confirms the AA's selection of the person whom AA arranges to meet.

The operation on the button 311 is transmitted from the terminal 31 to the cloud server 20 as a request for setting a place where to meet the selected person.

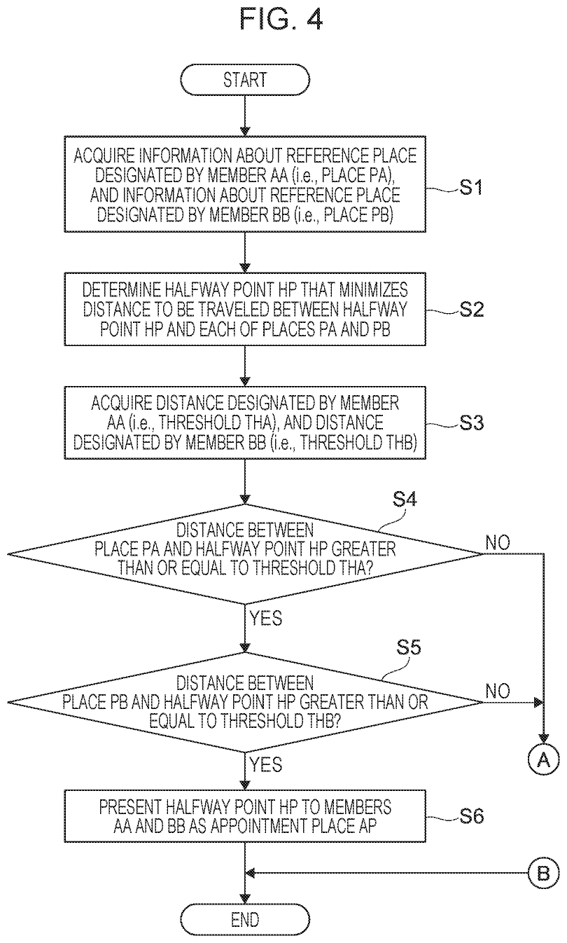

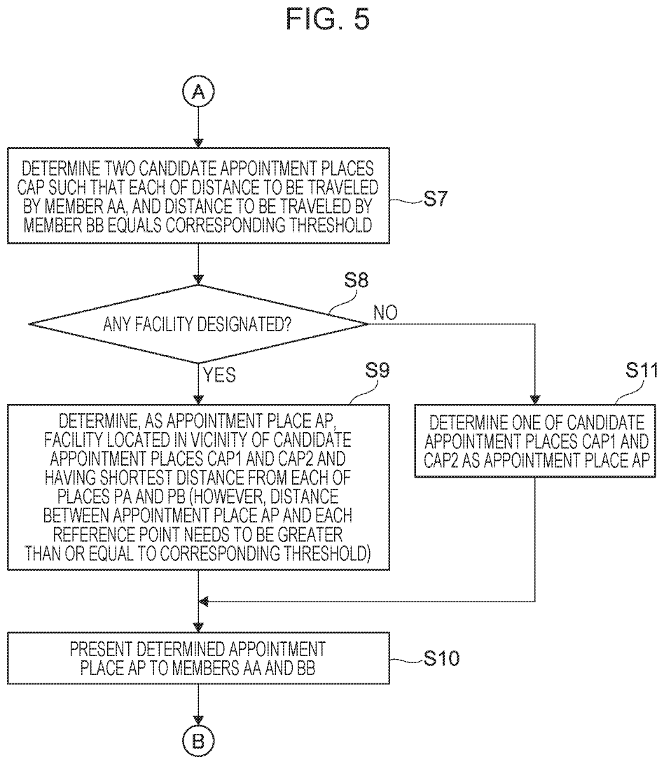

FIG. 4 is a flowchart illustrating a portion of processing executed in Exemplary Embodiment 1 to determine a meeting place. FIG. 5 is a flowchart illustrating another portion of processing executed in Exemplary Embodiment 1 to determine a meeting place. Symbol S in FIGS. 4 and 5 denotes step. The flowchart illustrated in each of FIGS. 4 and 5 represents an exemplary information presentation method.

The processing illustrated in FIGS. 4 and 5 is implemented through execution of a program by the processor 21 (see FIG. 1) of the cloud server 20 (see FIG. 1).

It is to be noted that the nickname XX corresponds to the member AA, and the nickname YY corresponds to the member BB. Accordingly, in FIGS. 4 and 5, members related to each process will be referred to as “member AA” and “member BB”.

First, the processor 21 acquires information about a reference place designated by the member AA (i.e., place PA), and information about a reference place designated by the member BB (i.e., place PB) (step 1). In Exemplary Embodiment 1, a reference place will be also referred to as “reference point”. As used in Exemplary Embodiment 1, the term reference point does not mean a coordinate point physically identified by latitude and longitude, but is intended to cover a range of area. For example, a range of area identified by the name of a geographical region, such as a town name or lot number, is also an example of a reference point. Further, for example, a range of area designated by the member AA or the member BB by bounding the range with lines is also an example of a reference point.

The places PA and PB serve as starting points for determining a meeting place. Since the places PA and PB serve as starting points, at least one such place PA and at least one such place B are set.

In Exemplary Embodiment 1, the places PA and PB are each set by a member. Specifically, the place PA is set via a screen displayed on the terminal 31 (see FIG. 1), and the place PB is set via a screen displayed on the terminal 32 (see FIG. 1). It is to be noted, however, that if each member's home or other specific place is set as a default value, the place set as a default value may be presented to the member. In this case, the member does not need to set a reference point. Additionally, it may be allowed to add a reference point or correct the default value.

In Exemplary Embodiment 1, during the process of accepting the setting of the places PA and PB serving as starting points, additional conditions related to the places PA and PB are also set. Specific examples of such additional conditions to be set include whether one wants to keep the places PA and PB serving as starting points unknown to the other person, and how much minimum distance one wants between a reference point and a meeting place.

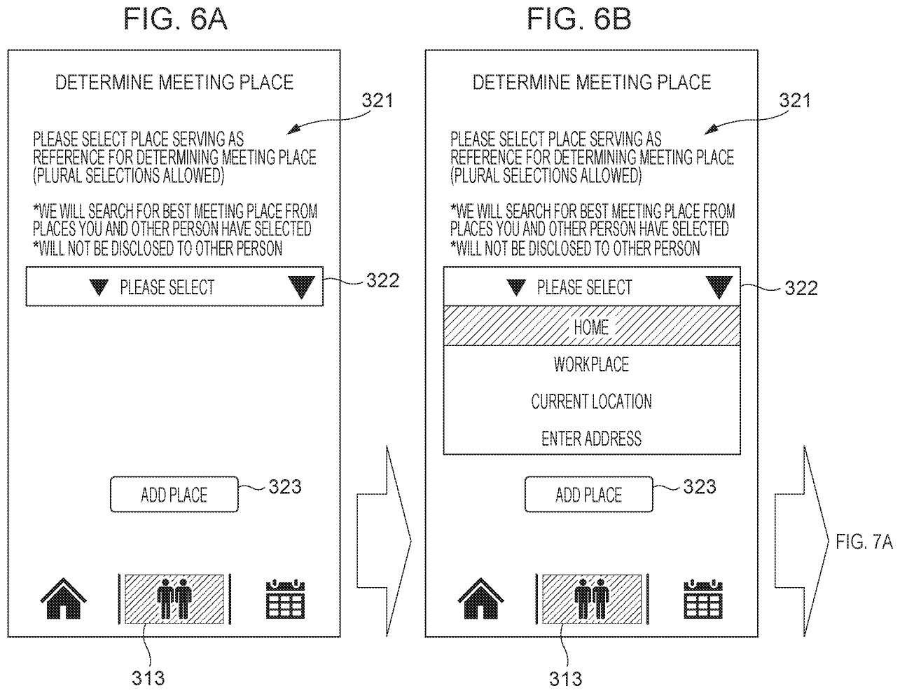

With reference to FIGS. 6A to 14, the following describes an example of screens presented to a member in association with step 1. In this regard, determining a meeting place also involves, for example, arranging a date and time between the parties concerned. In Exemplary Embodiment 1, it is assumed that such an arrangement has already been made or is to be made separately, and thus the following description will be directed to only processing related to determination of a meeting place and presentation of the determined meeting place.

FIGS. 6A and 6B each illustrate an exemplary screen for entering a condition used in determining a meeting place. FIG. 6A illustrates an initial screen. FIG. 6B illustrates a state in which one's home has been selected as a reference place.

The title of the screen illustrated in FIGS. 6A and 6B has been changed to “Determine a meeting place”.

The screen illustrated in each of FIGS. 6A and 6B has an area 321 that shows text explaining an operation that a member is asked to perform, an area 322 that shows choices of candidate places, and a button 323 used to confirm a selection.

The area 321 includes the following three pieces of text: “Please select a place serving as a reference for determining a meeting place (plural selections allowed)”; “We will search for the best meeting place from places that you and the other person have selected”; and “Will not be disclosed to the other person”.

The first piece of text shows what operation a member is asked to perform. The term “place serving as a reference” refers to a reference point as mentioned above. In Exemplary Embodiment 1, plural reference points may be set.

The second piece of text shows what processing is to be performed by using the reference point. It is appreciated from the second piece of text that the reference point is used to search for a meeting place.

The third piece of text shows that the reference point will not be disclosed to the other person. In Exemplary Embodiment 1, the cloud server 20 will not disclose, to the other person whom a member arranges to meet, not only the reference point but also an address registered by the member.

The area 322 shows choices of reference points. The area 322 in FIGS. 6A shows text prompting for a selection, and a pull-down button. Tapping the pull-down button in the area 322 in FIGS. 6A displays a list as illustrated in FIG. 6B. The list shows selectable reference points presented in list form. The list in FIG. 6B shows the following four selectable reference points: “Home”, “Workplace”, “Current location”, and “Enter an address”. The area 322 is an example of a first screen.

If one's home or workplace is selected, the processor 21 reads the corresponding address stored in the member database 23 (see FIG. 2) and uses the read address. In the case of FIGS. 6A and 6B, the row corresponding to “Home” has a different background color from the other three rows. This background color indicates that the corresponding choice has been selected. That is, in the case of FIGS. 6A and 6B, “Home” is currently being selected as a reference point.

If the selected choice is “Current location”, for example, a location given by the latitude and longitude measured by a global positioning system (GPS) receiver of the terminal 31 (see FIG. 1) is set as a reference point.

If the selected choice is “Enter an address”, a given address entered by a member is set as a reference point.

The button 323 in FIG. 6B is given the label “Add a place”. Tapping the button 323 with a place being selected in the area 322 confirms the selection of the place.

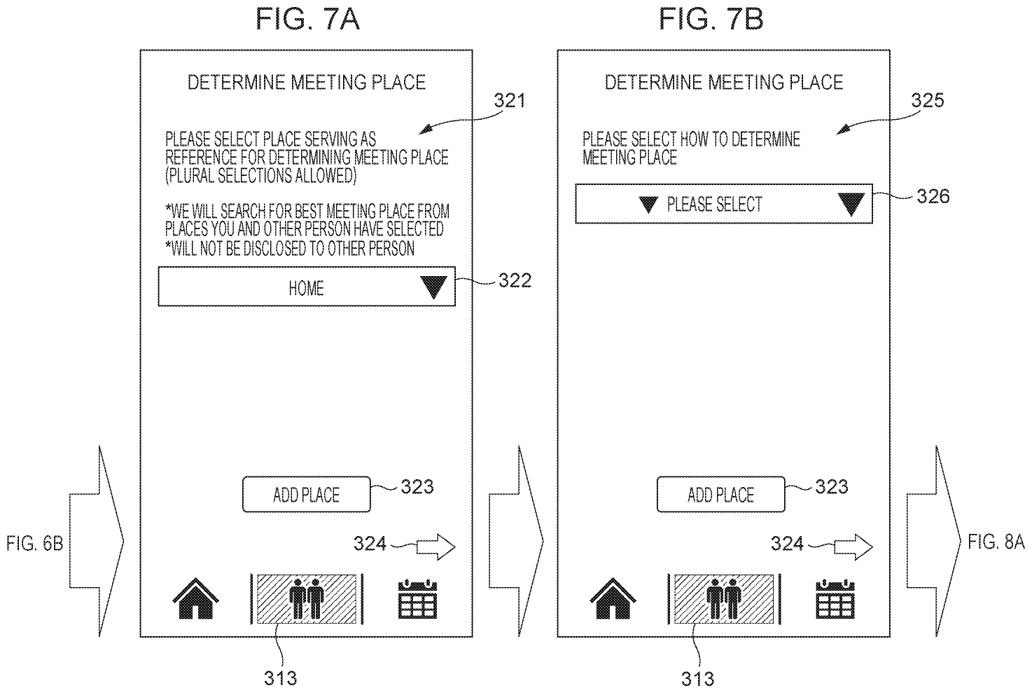

FIGS. 7A and 7B each illustrate an exemplary screen displayed at the point when the selection of a place used as a reference point has been made. FIG. 7A illustrates a state in which the selection of a place has been made. FIG. 7B illustrates a screen used for setting how to determine a meeting place.

In the case of FIG. 7A, the selection of a place has already been made, and thus the area 322 shows only “Home”. At this point, there is no need to prompt a member to select a reference point. Thus, the area 322 in FIG. 7A does not show text that prompts for the selection of a reference point. It is to be noted, however, that a pull-down button is shown at the right edge of the area 322 for when one wants to change a selected place. This is because at this point, the selection of a reference point by AA has not been confirmed yet.

In the case of FIG. 7A, below the button 323, an arrow 324 is shown in a highlighted state, the arrow 324 instructing that the screen be changed to the next screen. Tapping the arrow 324 with the fingertip confirms the selection of a reference point, and the processing transfers to the setting of the next condition. Specifically, a switch to the screen illustrated in FIG. 7B is executed.

The screen in FIG. 7B has an area 325 that shows text asking a member to set how to determine a meeting place, and an area 326 used to select another condition candidate.

In the case of FIG. 7B, the area 325 includes the text “Please select how to determine a meeting place”. This text shows what operation a member is asked to perform. This is because in Exemplary Embodiment 1, a meeting place is not to be designated by a member but is to be determined by the processor 21.

The area 326 in FIGS. 7B shows text prompting for a selection, and a pull-down button. In the case of FIG. 7B, how to determine a meeting place has not been selected yet, and thus the arrow 324 is shown in a grayed-out state.

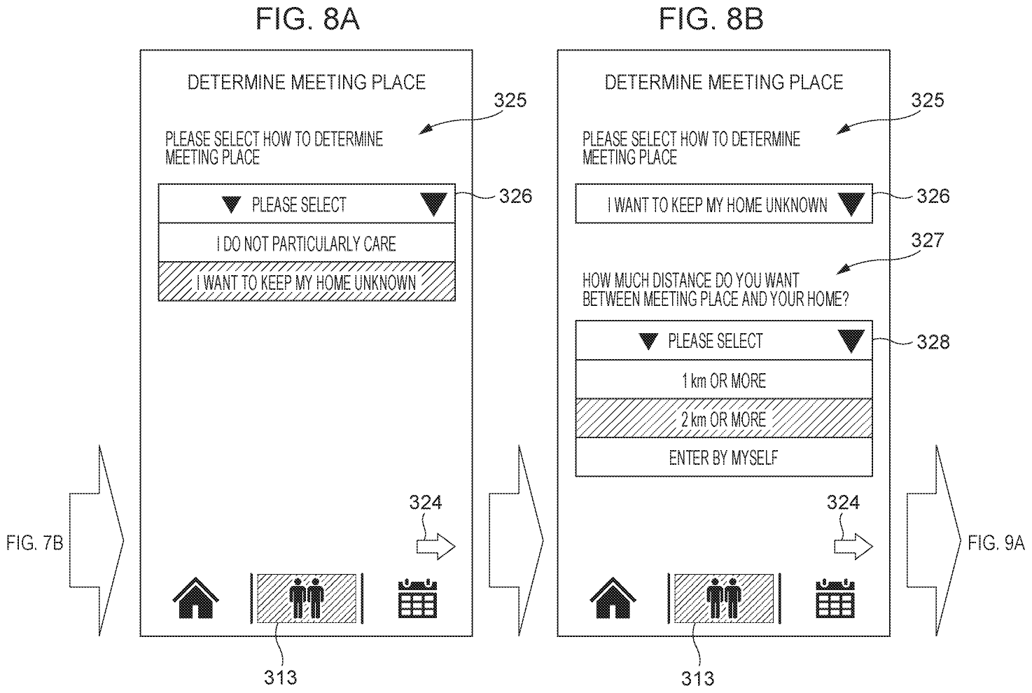

FIGS. 8A and 8B each illustrate an exemplary screen used to set the distance between a reference place and a meeting place. FIG. 8A illustrates a state in which the choice of wanting to keep a reference place unknown has been selected. FIG. 8B illustrates a screen used to set a distance. The screen in FIG. 8A is displayed when the pull-down button in the area 326 is tapped on the screen illustrated in FIG. 7B.

The area 326 in FIG. 8A shows a list of choices. This list includes choices used for asking a member whether he or she cares about how far a meeting place is from a reference point in determining the meeting place. There are the following two choices: “I do not particularly care” and “I want to keep my home unknown”. The reason why “Home” appears in the second choice is because “Home” has been selected as a reference point. Accordingly, if “Workplace” has been selected as a reference point, then the choice “I want to keep my workplace unknown” will appear in the second choice in the list.

As described above, the cloud server 20 according to Exemplary Embodiment 1 does not disclose the address of home or other such location registered by each member to other members. In this regard, however, if a meeting place and the member's home are located too close to each other, there is a greater risk of the member's home or other such location being found out based on the meeting place. For instance, if a person walks home from a meeting place, the person may be able to roughly guess the other person's daily living areas based on where the two persons have arranged to meet. If a person has his or her daily living areas found out by someone the person does not like, this potentially puts the person at risk.

Accordingly, in Exemplary Embodiment 1, the choice “I want to keep . . . unknown” means not only keeping one's home unknown to the other person but also keeping one's daily living areas unknown to the other person. Thus, the choice “I want to keep my home unknown” includes, for example, keeping the other person from finding out a facility that one frequently uses in the vicinity of his or her home, such as the nearest station.

In the case of FIG. 8A, the choice “I want to keep my home unknown” is shown in a highlighted state. At this point, some items to be set still remain, and thus the arrow 324 is in its grayed-out state.

The screen in FIG. 8B is displayed in response to the choice “I want to keep my home unknown” being tapped in the list shown in the area 326. The information in the area 326 thus changes to one showing the selected choice. That is, the area 326 now shows the selected choice “I want to keep my home unknown”.

If a member wants to keep a reference point unknown to the other person, the member is asked to set a distance as an additional condition. Accordingly, the screen in FIG. 8B has the following additional areas below the area 326: an area 327 that shows text asking a member to set a distance between a meeting place and his or her home; and an area 328 that shows choices of distances.

The area 327 in FIG. 8B includes the text “How much distance do you want between a meeting place and your home?”. This text prompts a member to perform an operation.

The first line in the area 328 illustrated in FIGS. 8B shows text prompting for a selection, and a pull-down button. It is to be noted, however, that the area 328 in FIG. 8B shows a list including plural choices. This is because the pull-down button shown in the area 326 has already been tapped. The list in the area 328 illustrated in FIG. 8B shows the following three choices: “1 km or more”, “2 km or more”, “Enter by myself”.

The distance in this case may be the distance in a straight line between one's home and a meeting place on a map (to be also referred to as “linear distance” hereinafter), or may be the distance along the travel path between one's home and a meeting place. In Exemplary Embodiment 1, the term distance is used to mean the linear distance. The distance in this context is an example of a threshold.

In FIG. 8B, the second choice, “2 km or more”, has been selected. Thus, the background color of the choice “2 km or more” differs from those of the other two choices. That is, a place located “2 km or more” away from one's home is being desired as a meeting place.

At this point as well, the setting has not been confirmed yet, and thus the arrow 324 is in its grayed-out state.

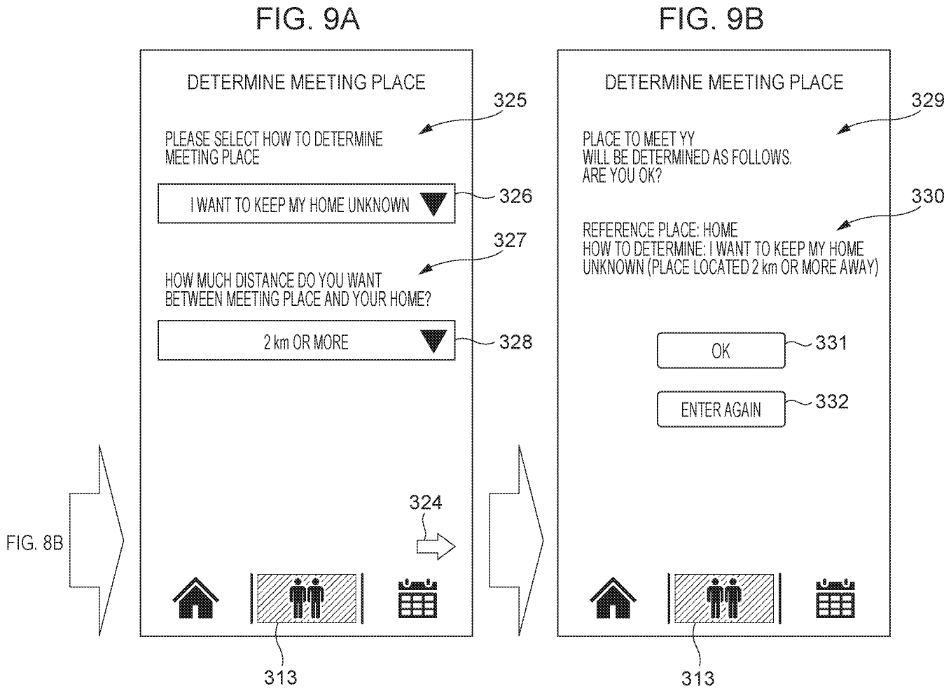

FIGS. 9A and 9B each illustrate an exemplary screen displayed after a desired distance between one's home and a meeting place is set. FIG. 9A illustrates a screen used to confirm selections made. FIG. 9B illustrates a screen used to check the confirmed information.

The screen in FIG. 9A is displayed in response to a tap on the row “2 km or more” in the area 328 illustrated in FIG. 8B.

Although the screen in FIG. 9A displays conditions selected by a member, changing of these conditions is possible until the arrow 324 is tapped. A pull-down button is thus shown in each of the areas 326 and 328.

On this screen, the arrow 324, which instructs that the screen be switched to the next screen, is shown in a highlighted state. Tapping the arrow 324 with the fingertip displays the screen illustrated in FIG. 9B.

The screen in FIG. 9B has the following components: an area 329 that shows text asking a member to perform a final check; an area 330 that shows a list of selections made; a button 331 used to finally confirm the selections made; and a button 332 used to return to a screen used for selecting conditions.

In the case of FIG. 9B, the area 329 includes the following text: “The place to meet YY will be determined as follows. Are you OK?”. As mentioned above, “YY” is the nickname of BB.

The area 330 shows a list of selections made. In the case of FIG. 9B, the area 330 shows the following pieces of information: the reference place (i.e., reference point) is one's home; and one wants one's home and a meeting place to be 2 km or more away from each other. Displaying the selections in the form of a single list in this way facilitates checking of information.

By tapping the button 331 labelled “OK”, the information described in the area 330 is transmitted to the cloud server 20 (see FIG. 1) as information representing how AA wishes a meeting place to be determined. At this time, tapping the button 332 labelled “Enter again” causes a return to, for example, the screen illustrated in FIGS. 6A. Alternatively, however, tapping the button 332 may cause a return to the screen illustrated in FIG. 9A, which is the immediately previous screen.

The manner in which to determine a meeting place may be set individually by AA and BB who arrange to meet, and information representing the manner of determination thus set is transmitted to the cloud server 20.

The reference point set by AA corresponds to the place PA at step 1, and the reference point set by BB corresponds to the place PB at step 1.

Once both AA and BB have finished setting how to determine a meeting place, the processor 21 terminates step 1 (see FIG. 4), and proceeds to determination of a meeting place.

If only one of AA and BB has finished the setting, the processor 21 is not allowed to proceed beyond step 1.

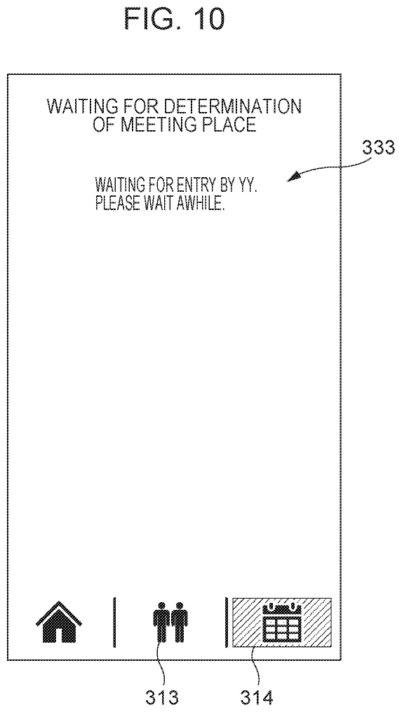

FIG. 10 illustrates an exemplary screen presented to a member who has finished setting how to determine a meeting place, when the other person has not finished the setting yet.

The screen shows the title “Waiting for the determination of a meeting place”. At this point, the icon 313 representing a couple at the bottom of the screen has changed to a grayed-out state, and instead, a building-shaped icon 314 representing a meeting place has changed to a highlighted state.

On the screen illustrated in FIG. 10, an area 333 shows text explaining the current status. In the case of FIG. 10, the area 333 shows the following text: “Waiting for entry by YY. Please wait awhile”. Through the text shown, AA realizes why a meeting place is not presented.

The following describes another exemplary screen related to setting how to determine a meeting place.

For instance, it may be conceivable for a single member to register plural places as reference places.

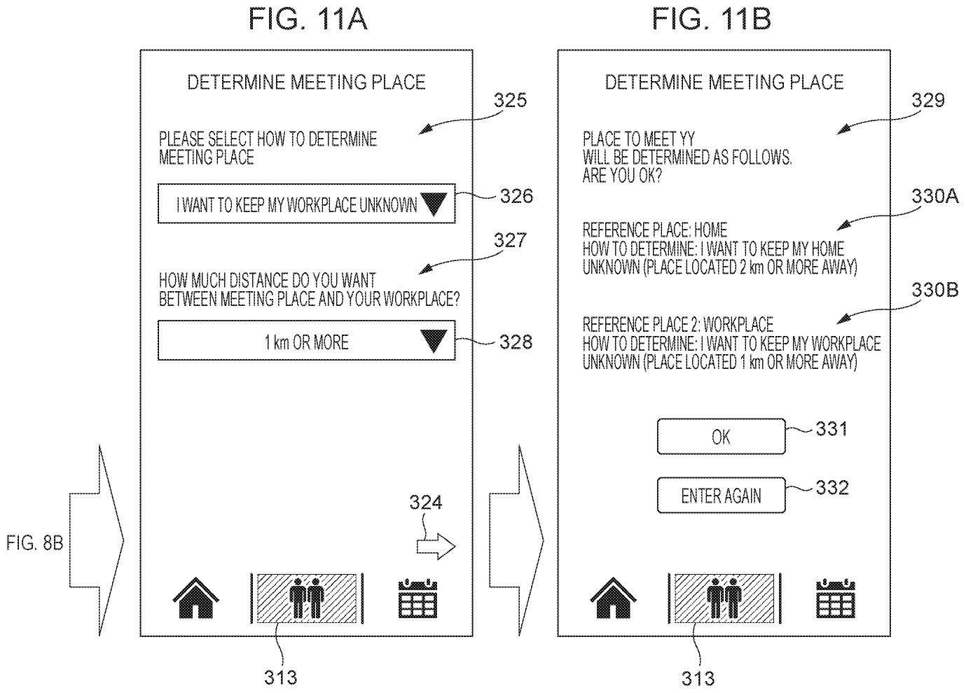

FIGS. 11A and 11B each illustrate an exemplary screen displayed in response to a workplace being selected as the second reference place. FIG. 11A illustrates a screen used to confirm selections made. FIG. 11B illustrates a screen used to check the confirmed information.

FIGS. 11A and 11B use the same or corresponding reference signs to refer to features corresponding to those in FIGS. 9A and 9B.

In the case of FIG. 11A, the area 326 shows the text “I want to keep my workplace unknown”, and the area 328 shows the text “1 km or more”. The differences from FIG. 9A are that the reference place is one's workplace, and that the desired distance between the workplace and a meeting place is 1 km or more, which is shorter than the desired distance between one's home and a meeting place. However, this does not necessarily mean that the distance between the finally determined meeting place and one's workplace is shorter than the distance between one's home and the meeting place.

The screen illustrated in FIG. 11B differs from the screen illustrated in FIG. 9B in that an area 330A shows settings made with respect to one's home, which is the first reference place, and that an area 330B shows settings made with respect to one's workplace, which is the second reference place.

Conceivably, some members may not care about the distance between their homes and a meeting place.

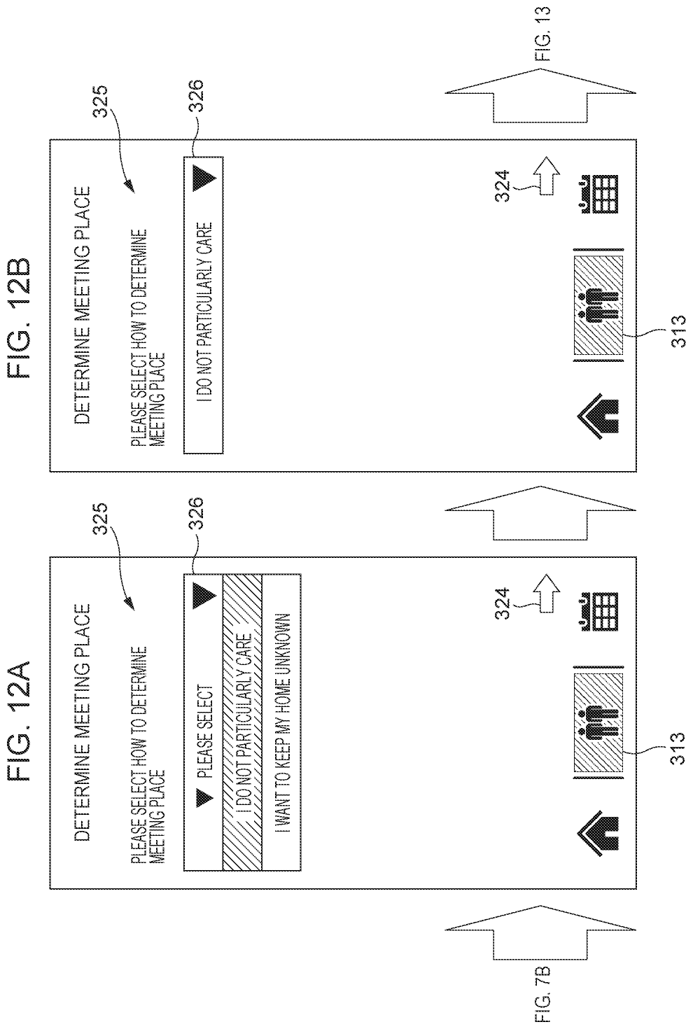

FIGS. 12A and 12B each explain an exemplary screen displayed if one does not particularly care about the distance between a reference point place and a meeting place. FIG. 12A illustrates a state in which the choice of not caring about the distance between a reference point and a meeting place has been selected, and FIG. 12B illustrates a screen displayed after the selection. The screen in FIG. 12A is displayed when the pull-down button in the area 326 is tapped on the screen illustrated in FIG. 7B.

In the case of FIG. 12A as well, the area 326 shows the following two choices: “I do not particularly care” and “I want to keep my home unknown”. In the case of FIG. 12A, however, the choice “I do not particularly care” has been tapped. Thus, the choice “I do not particularly care” is shown in a highlighted state. Subsequently, the screen switches to the screen in FIG. 12B.

The area 326 in FIG. 12B shows the text “I do not particularly care”. In this case, no distance setting is necessary. It is to be noted, however, that for data processing purposes, this may be handled as an indication that the distance to be provided between one's home and a meeting place has been set to 0 km or more. The area 326 in this case is an example of a third screen.

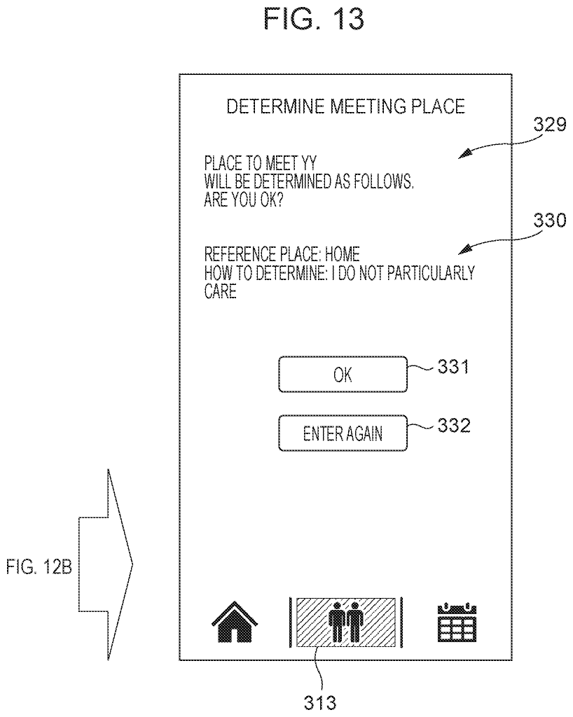

In this state, tapping the arrow 324, which is now shown in a highlighted state, with the fingertip displays the screen illustrated in FIG. 13.

FIG. 13 explains an exemplary screen displayed if the setting regarding the distance between a reference place and a meeting place is “I do not particularly care”. FIG. 13 uses the same or corresponding reference signs to refer to features corresponding to those in FIGS. 9A and 9B.

The screen in FIG. 13 as well has the following components: the area 329 that shows text asking a member to perform a final check; the area 330 that shows a list of selections made; the button 331 used to finally confirm the selections made; and the button 332 used to return to a screen used for selecting conditions.

In the case of FIG. 13, the following pieces of information are shown: the reference place (i.e., the reference point) is one's home; and the choice regarding how to determine a meeting place is “I do not particularly care”.

In some cases, the home of a member using the present service may be located in the suburbs or other such areas. For a member whose home is located in the suburbs or other such areas where available transportation choices are limited, the member may wish to have choices of distances greater than 2 km between a reference point and a meeting place. With such cases in mind, the screen illustrated in FIG. 8B offers the choice “Enter by myself”. This means that a member whose home is located in the suburbs or other such areas is asked to perform plural operations every time. Plural operations in this case include an operation of selecting the choice “Enter by myself”, and an operation of entering a specific numerical value.

Accordingly, the cloud server 20 according to Exemplary Embodiment 1 has the capability to switch which threshold candidates are presented to individual members, in accordance with the regional characteristics of a geographic region where the present service is provided.

As such regional characteristics, one or plural of the following characteristics of a geographical region where the present service is provided are used: population, population density, and station-to-station distances. For example, regions with many farmlands have less population or population density, and greater distances between stations than urban areas. In such regions, the number of potential candidates of places that may be used as meeting places is naturally limited.

Accordingly, members with their homes located in such regions are presented with choices of the distance between a reference point and a meeting place different from choices presented to members whose homes are located in urban areas.

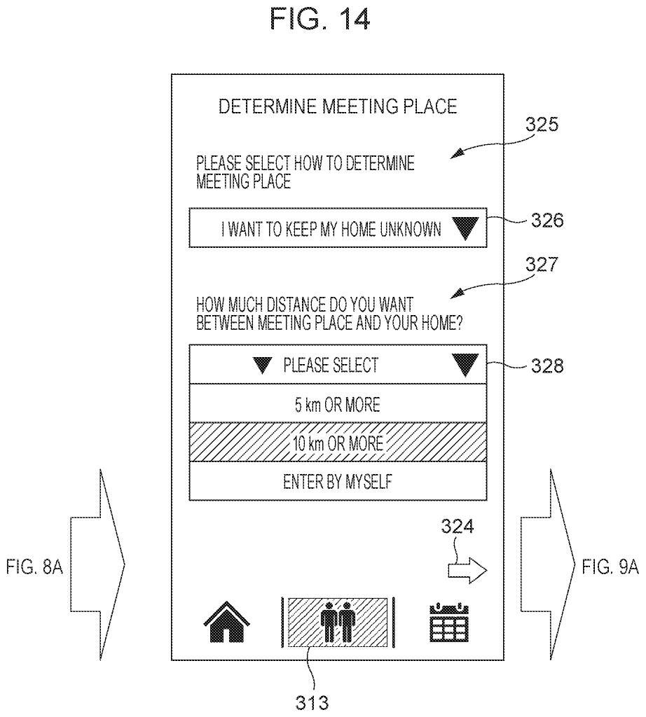

FIG. 14 illustrates an example in which distances that suit the characteristics of a geographical region are presented as choices. FIG. 14 uses the same or corresponding reference signs to refer to features corresponding to those in FIGS. 8A and 8B.

On the screen in FIG. 14, distance choices shown in the area 328 have been changed to “5 km or more” and “10 km or more”. The area 328 in this case is an example of a second screen.

As described above, the choices to be presented are changed in accordance with the characteristics of a geographical region where the present service is provided. This may help to increase the satisfaction of members. This may also increase the likelihood of a place far away from each member's daily living areas being determined as a meeting place.

The description now returns to FIG. 4.

Once the two persons who arrange to meet, AA and BB, have both finished setting a reference point and how to determine a meeting place, the processor 21 determines a halfway point HP that minimizes the distance to be traveled between the halfway point HP and each of the places PA and PB (step 2). Step 2 in FIG. 4 uses the “distance to be traveled”, and thus the distance used is the distance along the travel route. The halfway point HP may be also given as the midpoint of a line segment connecting the place PA and the place PB on a map. In another example, the halfway point HP may be determined to be a location that roughly equalizes the transportation cost or a location that roughly equalizes the time needed for travel.

Once the halfway point HP is determined, the processor 21 acquires a distance designated by the member AA (i.e., the threshold THA), and a distance designated by the member BB (i.e., the threshold THB) (step 3). Each of these distances refers to the distance selected in the area 328 (see FIG. 8B). For a member who does not care about the distance between a reference point and a meeting place, the threshold TH is set to 0 km.

Subsequently, the processor 21 determines whether the distance between the place PA and the halfway point HP is greater than or equal to the threshold THA (step 4). If an affirmative result is obtained at step 4, the processor 21 determines whether the distance between the place PB and the halfway point HP is greater than or equal to the threshold THB (step 5).

If an affirmative result is obtained at step 5 as well, the processor 21 presents the halfway point HP to the members AA and BB as an appointment place AP (step 6). As for steps 4 and 5, whichever one of the two steps may be executed earlier than the other.

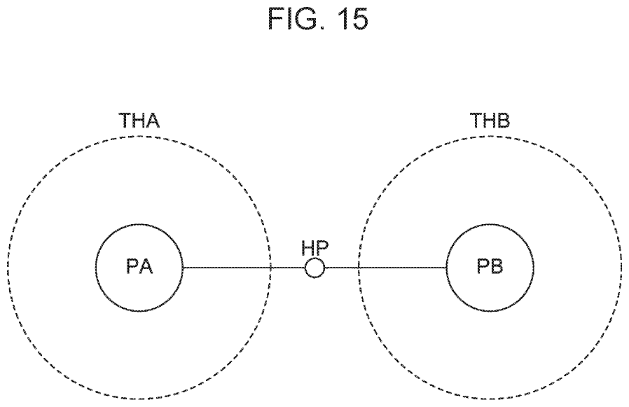

FIG. 15 illustrates the relationship between the halfway point HP, and the thresholds THA and THB for a case where an affirmative result is obtained at each of steps 4 and 5. The threshold THA and the threshold THB in FIG. 15 are the same. Of course, the threshold THA and the threshold THB may be different from each other.

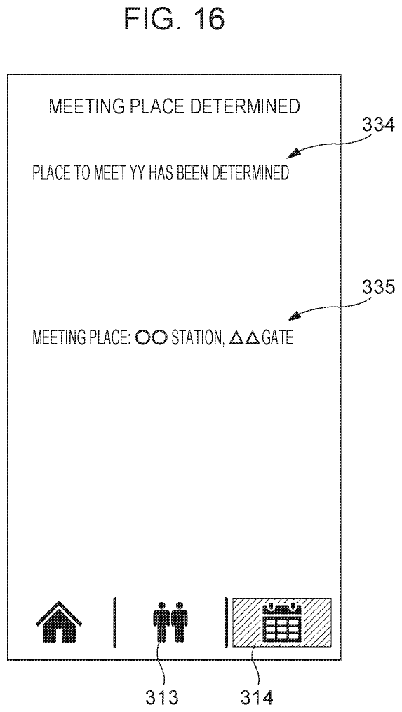

FIG. 16 explains an exemplary screen presented to each member if an affirmative result is obtained at each of steps 4 and 5. On this screen, the title has changed to “The meeting place has been determined”. The icon 313 representing a couple at the bottom of the screen has changed to a grayed-out state, and instead, the building-shaped icon 314 representing a meeting place has changed to a highlighted state.

On the screen illustrated in FIG. 16, an area 334 shows text explaining the current status. In the case of FIG. 16, the area 334 shows the text “The place to meet YY has been determined”. The meeting place is shown in an area 335 located below the area 334. In the case of FIG. 16, the following piece of information is shown: “◯◯ station, ΔΔ gate”.

Exemplary Embodiment 1 ignores whether the actual meeting at the halfway point HP is physically possible. For instance, it is possible that the halfway point HP may be located on a roadway or rail track, or in a river or private property. In such cases, as with step 9 described later, a facility existing in the vicinity of the halfway point HP needs to be presented as a meeting place.

The description now returns to FIG. 4.

If a negative result is obtained at step 4 or 5, the processor 21 proceeds to step 7 illustrated in FIG. 5. In this regard, if a negative result is obtained at step 4, this means that the distance set by AA as the distance between a reference point and the halfway point HP is less than the threshold THA set by AA. If a negative result is obtained at step 5, this means that the distance set by BB as the distance between a reference point and the halfway point HP is less than the threshold THB set by BB.

In this case, the processor 21 determines two candidate appointment places CAP such that each of the distance to be traveled by the member AA, and the distance to be traveled by the member BB equals the corresponding threshold (step 7).

In the case of step 7, the following two places are selected as such candidate appointment places CAP: a place for which the distance to be traveled by the member AA equals the threshold THA; and a place for which the distance to be traveled by the member BB equals the threshold THB.

Although FIG. 5 focus on the distance traveled, it is also possible to use the linear distance.

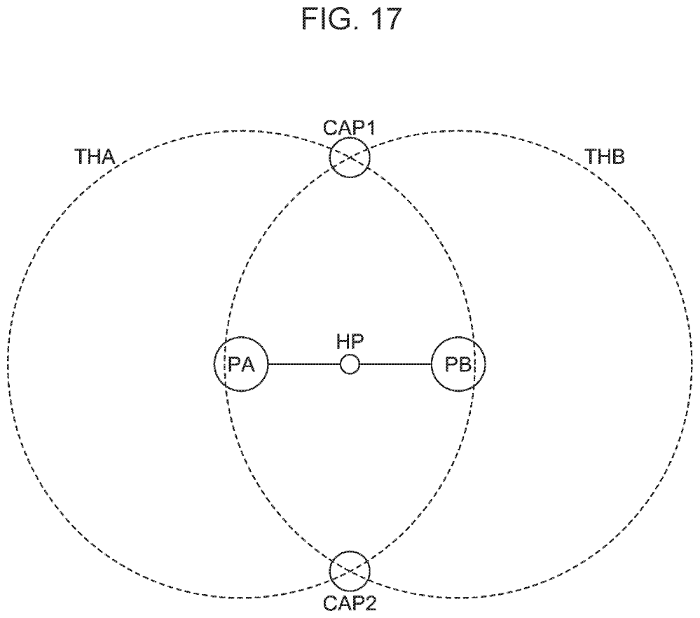

FIG. 17 explains an example of how candidate appointment places CAP1 and CAP2 are determined. In the case of FIG. 17, the halfway point HP lies inside a circle centered at the place PA, which is the reference point set by AA, and having a radius given by the threshold THA. Likewise, the halfway point HP lies inside a circle centered at the place PB, which is the reference point set by BB, and having a radius given by the threshold THB.

The candidate appointment places CAP1 and CAP2 are each located at the intersection of two circles, one with a radius equal to the threshold THA and the other with a radius equal to the threshold THB.

Although Exemplary Embodiment 1 uses the thresholds THA and THB individually set by the corresponding members, in an alternative implementation, the larger one of the two thresholds THA and THB may be used in determining the candidate appointment places CAP1 and CAP2. Even if the thresholds used for determining the candidate appointment places CAP1 and CAP2 are to be made uniform between AA and BB, the condition set by the member who has originally designated the smaller threshold is satisfied. It is to be noted, however, that using the same threshold for AA and BB does not necessarily roughly equalize the time needed for travel by AA and the time needed for travel by BB, nor does using the same threshold necessarily roughly equalize the transportation cost needed for travel by AA and the transportation cost needed for travel by BB. Accordingly, the way the candidate appointment places CAP1 and CAP2 are determined may be allowed to be changed in accordance with a setting made by a member.

In Exemplary Embodiment 1, from the viewpoint of ensuring that the distance to be traveled to a meeting place from a reference place set by each member does not become too great, the candidate appointment places CAP1 and CAP2 are determined by using the thresholds THA and THB set by individual members. Alternatively, however, it is also possible to set the candidate appointment places CAP1 and CAP2 by using a value greater than the thresholds THA and THB set by individual members. In this case, the distance to be used instead of the thresholds set by individual members may be changed in accordance with the characteristics of a geographical region to which a reference place belongs. For example, the distance to be used in the suburbs may be set greater than the distance to be used in urban areas.

In response to the candidate appointment places CAP1 and CAP2 being determined, the processor 21 determines whether any facility has been designated (step 8).

In Exemplary Embodiment 1, the result of determination at step 8 is affirmative if any facility has been designated by one of the two members who arrange to meet. The facility in this case is assumed to be a public place, examples of which include a train station, a famous building or monument, a restaurant, a hotel lounge, a department store, and a shopping mall.

Even if neither of the two members who arrange to meet has designated any facility to be used as a meeting place, a facility determined based on information such as the hobbies 240 in the member database 23 (see FIG. 1) may be used. In this case, the result of determination at step 8 is handled as being affirmative.

If an affirmative result is obtained at step 8, the processor 21 determines, as the appointment place AP, a facility located in the vicinity of the candidate appointment places CAP1 and CAP2 and at the shortest distance from each of the places PA and PB (step 9). It is to be noted, however, that the distance between the appointment place AP and each reference point needs to be greater than or equal to the corresponding threshold.

The term “vicinity” used with reference to step 8 means that the distance to the corresponding candidate appointment place CAP satisfies a predetermined condition. One example of the condition used in this case is that, with the candidate appointment place CAP1 or CAP2 taken as a starting point, none of the following values exceeds the corresponding upper limit; the linear distance; the distance of a path to be traveled; the time needed for travel; and the transportation cost needed for travel.

In Exemplary Embodiment 1, the “facility having the shortest distance from each of the place PA and the place PB” refers to, for example, a facility having the smallest sum of the distance from the place PA and the distance from the place PB.

It is to be noted, however, that the expression “having the shortest distance” may have either one of the following meanings: having the smallest sum of the distance to be traveled from the place PA and the distance to be traveled from the place PB; having the smallest sum of the time needed to travel from the place PA and the time needed to travel from the place PB; and having the smallest sum of the cost needed to travel from the place PA and the cost needed to travel from the place PB.

Instead of a facility “having the shortest distance”, a facility having the smallest score as calculated by a predetermined computational equation may be used.

An example of the computational equation used at this time is an equation below that has the following values as variables: the annual income of each member; and the cost needed for each member to travel.

Score=(AA's annual income (unit: 10,000 yen)×cost incurred by BB)+(BB's annual income (unit: 10,000 yen)×cost incurred by AA)

For instance, if AA's annual income is 8,000,000 yen and the cost incurred by AA is 400 yen, and BB's annual income is 3,000,000 yen and the cost incurred by BB is 100 yen, the resulting score is 200,000 (=(800×100)+(300×400)).

If AA's annual income is 8,000,000 yen and the cost incurred by AA is 450 yen, and BB's annual income is 3,000,000 yen and the cost incurred by BB is 50 yen, the resulting score is 175,000 (=(800×50)+(300×450)).

If AA's annual income is 8,000,000 yen and the cost incurred by AA is 200 yen, and BB's annual income is 3,000,000 yen and the cost incurred by BB is 300 yen, the resulting score is 300,000 (=(800×300)+300×200)).

According to this computational equation, provided that the total sum of costs paid by the two persons is the same, if the cost incurred by the member with the lower annual income is low, then the resulting score is lower than is otherwise the case.

In Exemplary Embodiment 1, for a facility to be determined as the appointment place AP, the distance between the facility and a reference point set by each member needs to be greater than or equal to the corresponding threshold. In other words, for a facility to be used as the appointment place AP, the facility needs to be located at a distance from the place PA greater than or equal to the threshold THA, and at a distance from the place PB greater than or equal to the threshold THB.

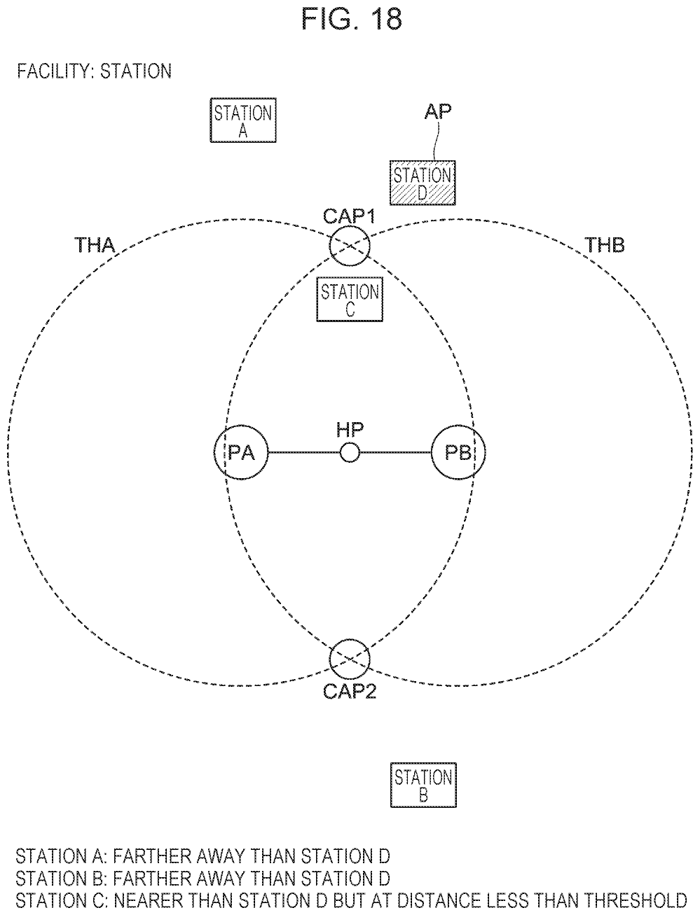

FIG. 18 explains a specific example of how to determine the appointment place AP. FIG. 18 uses the same or corresponding reference signs to refer to features corresponding to those in FIG. 17.

In the case of FIG. 18, train stations are used as facilities to meet at. In the case of FIG. 18, the facility at the shortest distance to each of the places PA and PB is a station C. The distance between a station D and each of the places PA and PB is greater than the distance between the station C and each of the places PA and PB. The distance between a station A and each of the places PA and PB is greater than the distance between the station D and each of the places PA and PB. The distance between a station B and each of the places PA and PB is greater than the distance between the station A and the each of places PA and PB.

It is to be noted, however, that in the case of FIG. 18, the station C with the shortest distance is located inside a circle determined by the threshold THA and a circle determined by the threshold THB. The station C is thus excluded from possible selection for the appointment place AP. As a result, in the case of FIG. 18, the station D is determined to be the appointment place AP.

The description now returns to FIG. 5.

In response to the appointment place AP being determined at step 9, the processor 21 presents the determined appointment place AP to the members AA and BB (step 10). The appointment place AP is presented by using the above-mentioned screen illustrated in FIG. 16.

If a negative result is obtained at step 8, the processor 21 determines one of the candidate appointment places CAP1 and CAP2 as the appointment place AP (step 11).

One exemplary method for determining the appointment place AP is to first assign an even number to one of the candidate appointment places CAP1 and CAP2 and assign an odd number to the other, and to determine the appointment place AP based on whether a random number generated by a randomizer is an even number or an odd number.

Another exemplary method is to determine, as the appointment place AP, one of the candidate appointment places CAP1 and CAP2 with the greater number of predetermined types of stores.

Another exemplary method is to determine, as the appointment place AP, one of the candidate appointment places CAP1 and CAP2 with the greater population or population density.

In response to the appointment place AP being determined at step 11, the processor 21 presents the determined appointment place AP to the members AA and BB (step 10). The appointment place AP is presented by using the above-mentioned screen illustrated in FIG. 16.

### Exemplary Embodiment 2

Exemplary Embodiment 2 is directed to a case where there are three or more members who arrange to meet.

In Exemplary Embodiment 2 as well, the cloud system 1 (see FIG. 1) described above with reference to Exemplary Embodiment 1 is used.

The difference from Exemplary Embodiment 1 resides in the details of a program executed by the processor 21 (see FIG. 1).

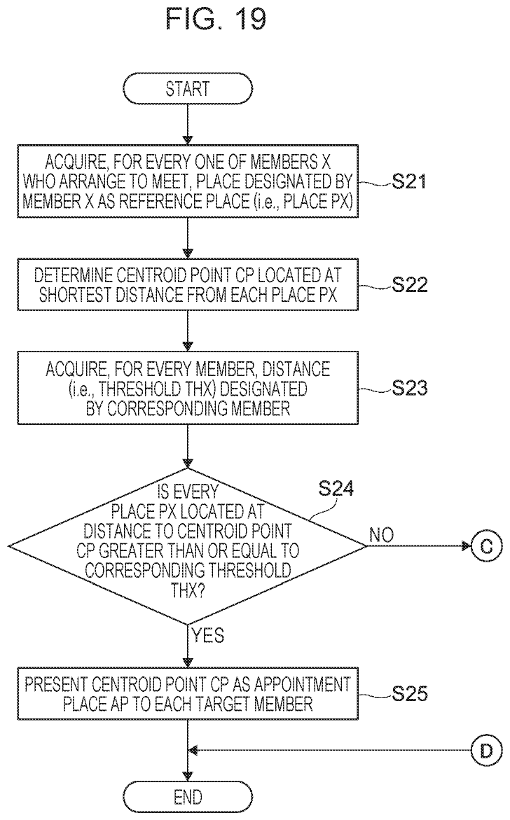

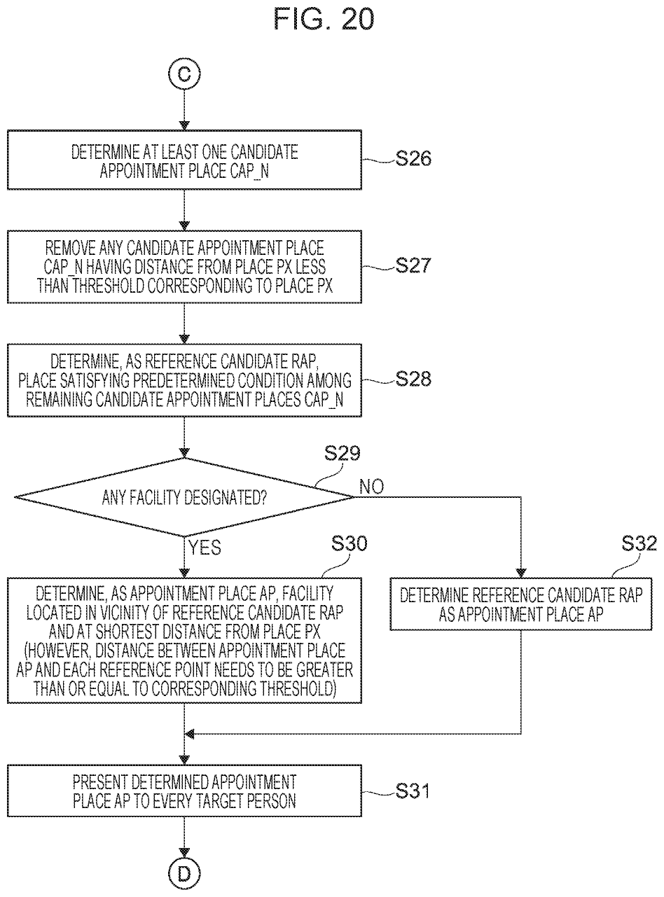

With reference to FIGS. 19 and 20, an example of processing executed by the cloud server 20 (see FIG. 1) will be described below.

FIG. 19 is a flowchart illustrating a portion of processing executed in Exemplary Embodiment 2 to determine a meeting place. FIG. 20 is a flowchart illustrating another portion of processing executed in Exemplary Embodiment 2 to determine a meeting place. Symbol S in FIGS. 19 and 20 denotes step. The flowchart illustrated in each of FIGS. 19 and 20 represents an exemplary information presentation method.

The processing illustrated in FIGS. 19 and 20 is implemented through execution of a program by the processor 21 of the cloud server 20.

First, the processor 21 acquires, for every one of members X who arrange to meet, a place designated by the member X as a reference place (i.e., place PX) (step 21). The specific procedure by which each member X designates the place PX is the same as that described above with reference to Exemplary Embodiment 1, and thus will not be described in further detail.

Subsequently, the processor 21 determines a centroid point CP located at the shortest distance from each place PX (step 22). In the case of Exemplary Embodiment 2, the centroid point CP is determined to be the place having the smallest sum total of linear distances from individual places PX.

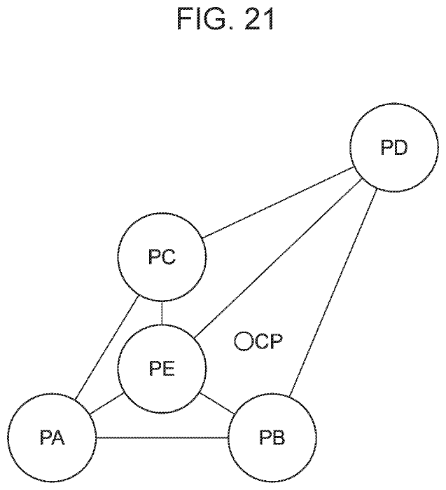

FIG. 21 explains an example of how the centroid point CP is determined if there are five persons who arrange to meet. In the case of FIG. 21, the five persons who arrange to meet are AA, BB, CC, DD, and EE. In FIG. 21, PA represents a reference point set by AA, PB represents a reference point set by BB, PC represents a reference point set by CC, PD represents a reference point set by DD, and PE represents a reference point set by EE.

It is to be noted, however, that the centroid point CP may be determined by other methods.

In one example, the centroid point CP may be determined to be a place having the smallest sum total of distances to be traveled from individual places PX to the centroid point CP. In another example, the centroid point CP may be determined to be a place having the smallest sum total of costs needed to travel from individual places PX to the centroid point CP.

In still another example, the centroid point CP may be determined to be the centroid of a polygon formed by connecting all of the places PX by line segments and then extracting the outermost line segments. In the example in FIG. 21, the centroid point CP may be determined as the centroid of a quadrilateral made up of the following line segments: a line segment connecting the place PA and the place PB; a line segment connecting the place PB and the place PD; a line segment connecting the place PD and the place PC; and a line segment connecting the place PC and the place PA.

The description now returns to FIG. 19.

The processor 21 now acquires, for every member, a distance (i.e., threshold THX) designated by the corresponding member (step 23).

Subsequently, the processor 21 determines whether, for every place PX, the distance between the place PX and the centroid point CP is greater than or equal to the corresponding threshold THX (step 24).

If an affirmative result is obtained at step 24, the processor 21 presents the centroid point CP as the appointment place AP to each target member (step 25). The appointment place AP is presented by using the above-mentioned screen illustrated in FIG. 16.

If a negative result is obtained at step 24, the processor 21 proceeds to step 26 illustrated in FIG. 20. In this regard, if a negative result is obtained at step 24, this means that the distance between the determined centroid point CP and at least one place PX is less than a threshold set by the corresponding member.

In this case, the processor 21 determines at least one candidate appointment place CAP_N (step 26). At step 26, plural candidate appointment places CAP_N are determined.

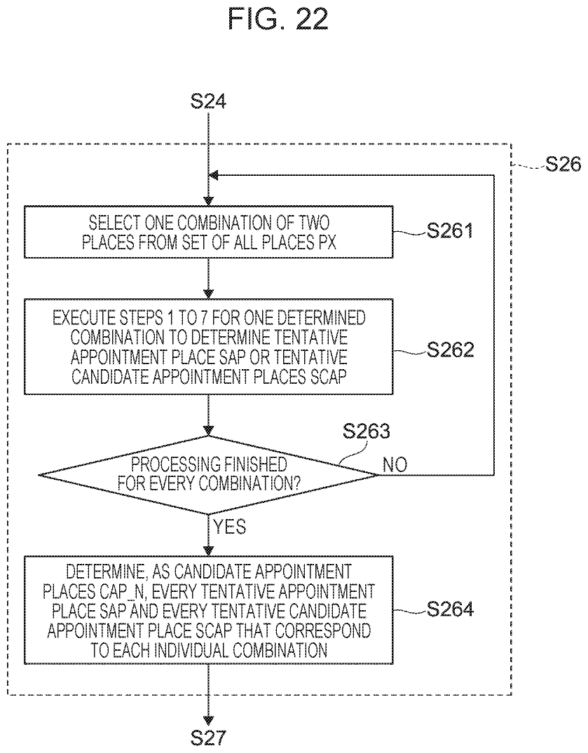

FIG. 22 is a flowchart illustrating exemplary processing executed at step 26. Steps 1 to 7 appearing in FIG. 22 correspond to the processing illustrated in each of FIGS. 4 and 5. The flowchart illustrated in FIG. 22 represents an exemplary information presentation method.

First, the processor 21 selects one combination of two places from the set of all places PX (step 261). In the example in FIG. 21, there are five places PX, and thus one combination is selected from a total of ten combinations calculated by ₅C₂.

Subsequently, the processor 21 executes steps 1 to 7 with respect to the one selected combination to determine a tentative appointment place SAP or tentative candidate appointment places SOAP (step 262). In this case, the tentative appointment place SAP corresponds to the halfway point HP presented at step 6 (see FIG. 4), and the tentative candidate appointment places SOAP correspond to the candidate appointment places CAP1 and CAP2 determined at step 11 (see FIG. 5).

After step 262 is finished, the processor 21 determines whether the above-mentioned processing has been finished for every combination (step 263).

If a negative result is obtained at step 263, the processor 21 returns to step 261, where the processor selects one combination that has not been processed yet.

If an affirmative result is obtained at step 263, the processor 21 determines, as candidate appointment places CAP_N, every tentative appointment place SAP and every tentative candidate appointment place SCAP that correspond to each individual combination (step 264).

The description now returns to FIG. 20.

Once step 26 is finished, the processor 21 removes any candidate appointment place CAP_N having a distance from the place PX less than a threshold corresponding to the place PX (step 27). The distance at this time may be a linear distance, the distance to be travelled, or other distances mentioned above.

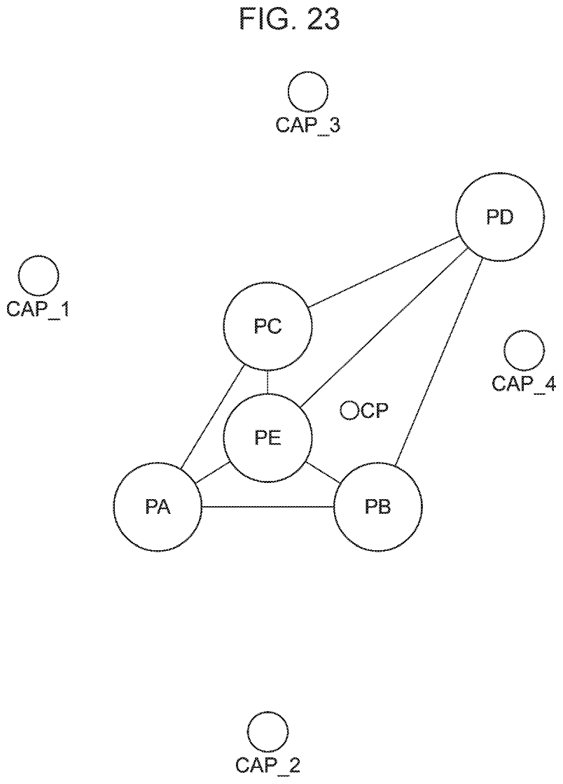

FIG. 23 illustrates an example of candidate appointment places CAP_N that have remained without being removed at step 27. FIG. 23 is based on the arrangement in FIG. 21.

In the case of FIG. 23, there are four candidate appointment places CAP_N including CAP_1, CAP_2, CAP_3, and CAP_4.

The description now returns to FIG. 20.

Subsequently, the processor 21 determines, as a reference candidate RAP, a place that satisfies a predetermined condition among the remaining candidate appointment places CAP_N (step 28).

In the case of Exemplary Embodiment 2, the predetermined condition used is that the reference candidate RAP be a place with the shortest linear distance from the centroid point CP determined at step 22 (see FIG. 19).

However, other conditions may be used as well. Another example of the predetermined condition may be that the reference candidate RAP be a place that allows for the shortest distance to be traveled from the centroid point CP determined at step 22 (see FIG. 19). Another example of the predetermined condition may be that the reference candidate RAP be a place with the smallest sum total of distances to be traveled from the places PX corresponding to all of the members who arrange to meet. Another example of the predetermined condition may be that the reference candidate RAP be a place with the smallest sum total of times needed for travel by all of the members who arrange to meet. Another example of the predetermined condition may be that the reference candidate RAP be a place with the smallest sum total of costs needed for travel by all of the members who arrange to meet.

In any case, one reference candidate RAP is determined from the candidate appointment places CAP_N.

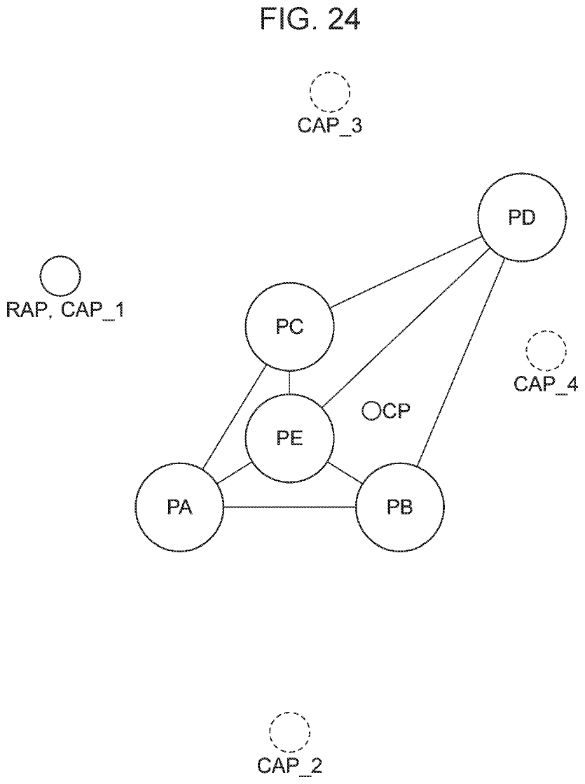

FIG. 24 explains an example of how the reference candidate RAP is determined. In the case of FIG. 24, the candidate appointment place CAP_1 is determined to be the reference candidate RAP.

The description now returns to FIG. 20.

In response to the reference candidate RAP being determined, the processor 21 determines whether any facility has been designated (step 29).

If an affirmative result is obtained at step 29, the processor 21 determines, as the appointment place AP, a facility located in the vicinity of the reference candidate RAP and at the shortest distance from the place PX (step 30). It is to be noted, however, that the distance between the appointment place AP and each reference point needs to be greater than or equal to the corresponding threshold.

The term “vicinity” as used with reference to step 30 has the same meaning as the term “vicinity” mentioned above with reference to Exemplary Embodiment 1.

In Exemplary Embodiment 2, the term “facility at the shortest distance from the place PX” refers to a facility with the smallest sum total of distances from individual places PX. It is to be noted, however, that as with Exemplary Embodiment 1, the term may be used to mean a facility with the smallest sum total of distances to be traveled from individual places PX, a facility with the smallest sum of the time needed to travel from the place PA and the time needed to travel from the place PB, or a facility with the smallest sum of the cost needed to travel from the place PA and the cost needed to travel from the place PB. Alternatively, the term may be used to mean a facility with the smallest score as calculated by a predetermined computational equation.

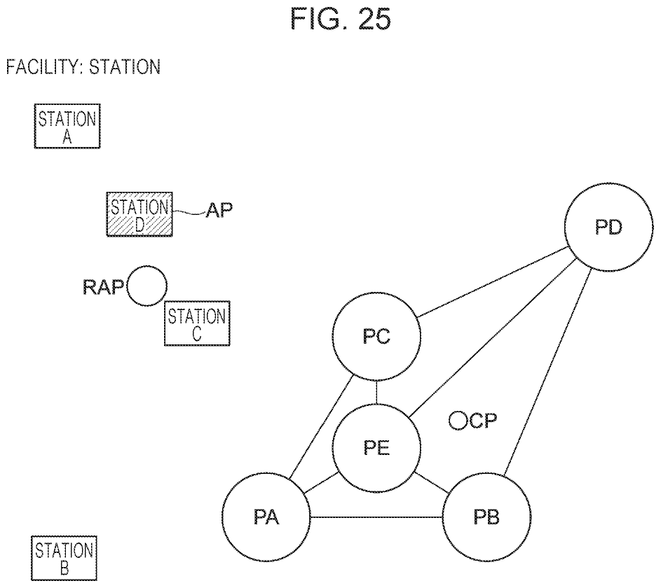

FIG. 25 explains a specific example of how to determine the appointment place AP. FIG. 25 uses the same or corresponding reference signs to refer to features corresponding to those in FIG. 24.

In the case of FIG. 25, train stations are used as facilities to meet at. In the case of FIG. 25, the facility with the shortest distance to the centroid point CP is the station C. The distance between the station D and the centroid point CP is greater than the distance between the station C and the centroid point CP, the distance between the station A and the centroid point CP is greater than the distance between the station D and the centroid point CP, and the distance between the station B and the centroid point CP is greater than the distance between the station A and the centroid point CP.

It is to be noted, however, that in the case of FIG. 25 as well, the distance between the centroid point CP and the station C closest to the centroid point CP is not greater than or equal to the threshold THX. The station C is thus excluded from possible selection for the appointment place AP. As a result, in the case of FIG. 25 as well, the station D is determined to be the appointment place AP.

The description now returns to FIG. 20.

In response to the appointment place AP being determined at step 30, the processor 21 presents the determined appointment place AP to every target person (step 31). The appointment place AP is presented by using the above-mentioned screen illustrated in FIG. 16.

If a negative result is obtained at step 29, the processor 21 determines the reference candidate RAP as the appointment place AP (step 32).

The candidate RAP is a single place as illustrated in FIG. 24. Thus, the reference candidate RAP is used as the appointment place AP as it is.

In response to the appointment place AP being determined at step 32, the processor 21 presents the determined appointment place AP to every target person (step 31). The appointment place AP is presented by using the above-mentioned screen illustrated in FIG. 16.

### Exemplary Embodiment 3

The following description of Exemplary Embodiment 3 will be directed to a method that allows for faster determination of the appointment place AP than Exemplary Embodiment 2.

The difference of Exemplary Embodiment 3 from Exemplary Embodiment 2 resides in processing performed at step 26 illustrated in FIG. 20. In Exemplary Embodiment 3, a process to be replaced with step 26 illustrated in FIG. 20 is denoted as step 26A.

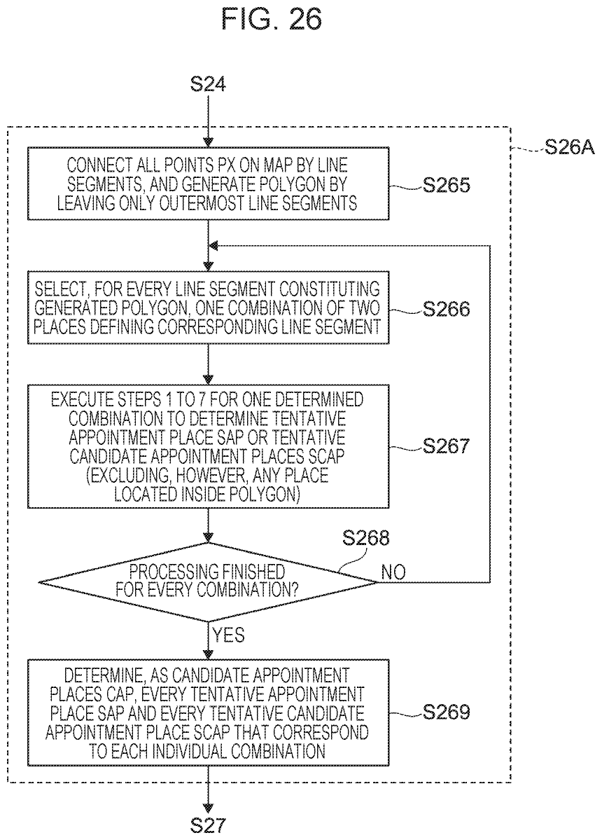

FIG. 26 is a flowchart illustrating exemplary processing executed at step 26A. The flowchart illustrated in FIG. 26 represents an exemplary information presentation method.

First, the processor 21 connects all points PX on a map by line segments, and generates a polygon by leaving only the outermost line segments of these line segments (step 265).

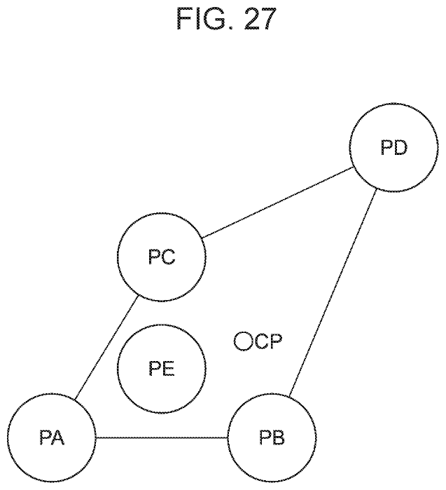

FIG. 27 explains the polygon generated at step 265. FIG. 27 uses the same or corresponding reference signs to refer to features corresponding to those in FIG. 21. In FIG. 27, the generated polygon is a quadrilateral made up of the following line segments: a line segment connecting the place PA and the place PB; a line segment connecting the place PB and the place PD; a line segment connecting the place PD and the place PC; and a line segment connecting the place PC and the place PA. In the case of FIG. 27, a convex quadrilateral is generated.

The description now returns to FIG. 26.

In response to the generation of the polygon, the processor 21 selects, for every line segment that makes up the generated polygon, one combination of two places defining the corresponding line segment (step 266). In the example in FIG. 27, one line segment to be processed is determined from among four line segments. Although there are ten such combinations in Exemplary Embodiment 2, only four combinations suffice in Exemplary Embodiment 3.

Subsequently, the processor 21 executes steps 1 to 7 for the one determined combination to determine a tentative appointment place SAP or tentative candidate appointment places SCAP (step 267). It is to be noted, however, that any place located inside the polygon is excluded from possible selection for the tentative appointment place SAP or tentative candidate appointment places SCAP.

After step 267 is finished, the processor 21 determines whether the above-mentioned processing has been finished for every combination (step 268).

If a negative result is obtained at step 268, the processor 21 returns to step 265, where the processor selects one combination that has not been processed yet.

If an affirmative result is obtained at step 268, the processor 21 determines, as candidate appointment places CAP, every tentative appointment place SAP and every tentative candidate appointment place SCAP that correspond to each individual combination (step 269).

Exemplary Embodiment 3 may help to reduce the number of loops of steps 266 to step 268 in comparison to the number of loops executed in Exemplary Embodiment 2, leading to a corresponding reduction in the time necessary for determining the tentative appointment place SAP and the tentative candidate appointment places SCAP. This may result in reduced time necessary for determining the appointment place AP.

### Other Exemplary Embodiments

Although exemplary embodiments of the present disclosure have been described above, the technical scope of the present disclosure is not limited to the above-mentioned exemplary embodiments. It is apparent from the description of the claims that various modifications or improvements of the exemplary embodiments also fall within the technical scope of the present disclosure.

(1) For example, Exemplary Embodiment 1 described above is directed to a process in which two members who arrange to meet each designate a single reference point in determining a meeting place. Thus, two reference points in total are designated. Alternatively, if each single member is to designate plural reference points, the process described above with reference to each of Exemplary Embodiments 2 and 3 may be employed.

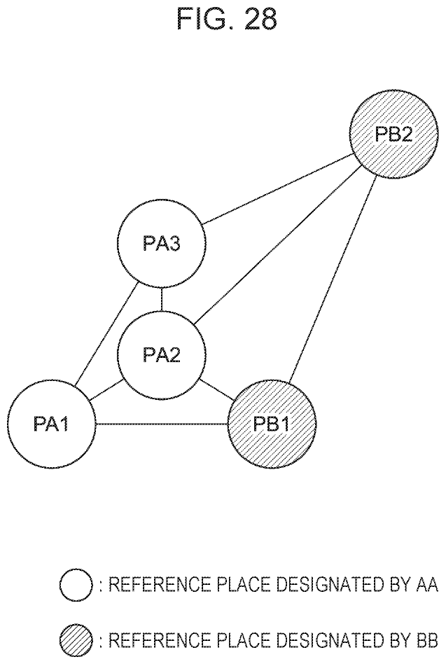

FIG. 28 explains a case in which each of members who arrange to meet designates plural places as reference points.

In the case of FIG. 28 as well, there are two persons, AA and BB, who arrange to meet. In the case of FIG. 28, AA designates three reference places. In FIG. 28, these reference places are represented as places PA1, PA2, and PA3. BB designates two reference places. In FIG. 28, these reference places are represented as places PB1 and PB2.

In practice, one may not necessarily have only one place that he or she does not want the other person to know. For instance, in some cases, one may not want the other person to know which school he or she goes to or where he or she works part-time. In other cases, one may not want the other person to know his or her current location.

If a single person is to designate plural reference points, a number of distances equal to that for two persons are used to perform the determination according to Exemplary Embodiment 2. However, otherwise, the processing described above with reference to FIGS. 19, 20, 22, and 26 may be used as it is.

(2) In the foregoing description of the exemplary embodiments, the appointment place AP is determined to be the nearest facility that satisfies a condition regarding the distance from a reference point designated by each of members who arrange to meet. Alternatively, a condition regarding the characteristics of a travel path may be additionally used in determining the appointment place AP. For example, the meeting place (i.e., the appointment place AP) may be determined to be a place with a greater number of available routes between a reference point and the meeting place (i.e., appointment place AP) than other places.

Examples of the meeting place in this case include not only facilities but also the halfway point HP, the centroid point CP, and candidate appointment places CAP.

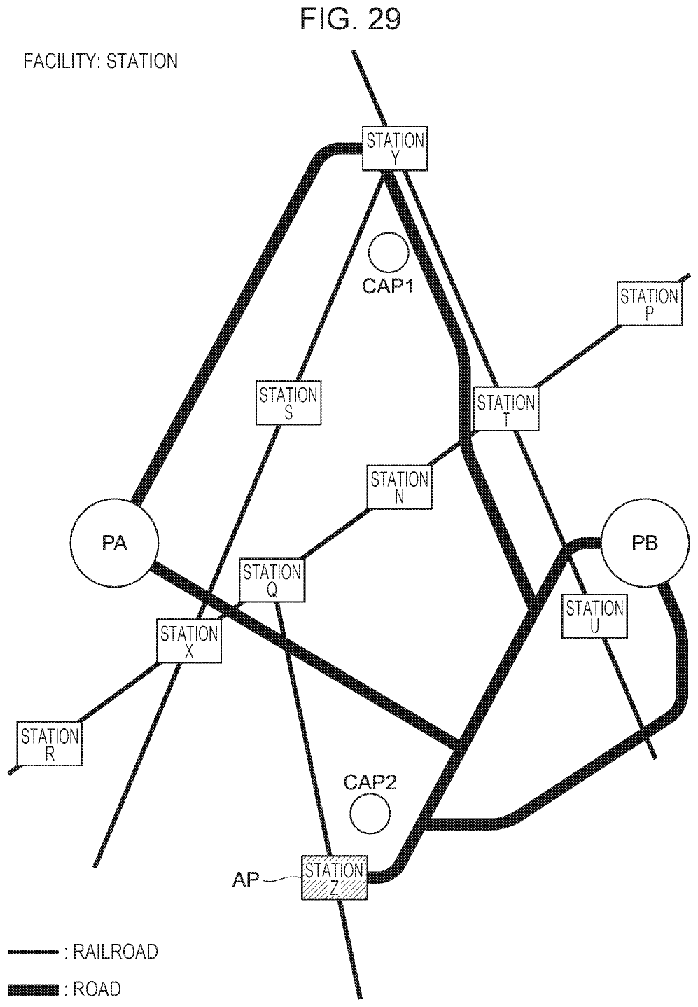

FIG. 29 explains a case in which a place that allows for a greater number of available routes than other places is determined to be the appointment place AP. In the case of FIG. 29 as well, there are two persons, AA and BB, who arrange to meet. Thus, there are two reference points, the place PA and the place PB. In the case of FIG. 29, there are two candidate appointment places CAP1 and CAP2. In the case of FIG. 29, a facility is designated. Specifically, train stations are designated as such a facility. In this case, one of a station Y and a station Z, which are respectively located in the vicinity of the candidate appointment places CAP1 and CAP2, is determined to be the appointment place AP.

In the case of FIG. 29, the number of available routes from the station Y to the place PA is two, including a path using a road that connects the station Y to the place PA, and a path using a railroad that passes the station Y, a station S, and then a station X. The number of routes from the station Y to the place PB is two, including a path using a road that connects the station Y to the place PB, and a path using a railroad that passes the station Y, a station T, and then a station U. Thus, there are a total of four routes available for travelling from the station Y taken as a starting point.

The number of routes from the station Z to the place PA is two, including a path using a road that connects the station Z to the place PA, and a path using a railroad that passes the station Z, a station Q, and then a station X. The number of routes from the station Z to the place PB is three, including two paths each using a road that connects the station Z to the place PB, and a path using a railroad that passes the station Z, the station Q, a station N, the station T, and then the station U. Thus, there are a total of five routes available for travelling from the station Y taken as a starting point. In this case, the station Z, which allows for the greater number of available routes, is determined to be the appointment place AP.

In the foregoing description, the number of routes is counted with a facility taken as a starting point, the facility being a candidate appointment place AP. This is because the greater the number of available route choices on the way home after a meeting, the less likely the reference places PA and PB are to be found out by the other person.

It is to be noted, however, that the number of routes may be counted with a reference place taken as a starting point. This is because the number of available routes on the way to a meeting place may differ from the number of available routes on the way back.

Alternatively, provided that the number of available routes counted is the same between different places, preference may be given to a place that allows for a greater number of available routes between the place and a reference point set by the female member. This is because under prevailing social conventions, protection of women is given preference over that of men.

In counting the number of routes, even if a single member has designated plural reference places, the number of routes may be counted only with respect to the member's home. This is because, conceivably, one's home has higher priority than other places as a reference point that one does not want the other person to know. Further, this narrows the number of reference points used in counting the number of routes to one, thus allowing for reduced computational load. It is to be noted, however, that each member may be allowed to choose which reference point is to be used in counting the number of routes.

(3) In the exemplary embodiments above, the nearest facility that satisfies a condition regarding the distance from a reference point designated by each of members who arrange to meet is determined to be the appointment place AP. Alternatively, a place that allows for a smaller distance of path overlap with another person may be determined to be a meeting place. This method also represents an exemplary method that uses a condition regarding travel path characteristics in determining the appointment place AP.

As with the aforementioned cases, examples of the meeting place in this case include not only facilities but also the halfway point HP, the centroid point CP, and candidate appointment places CAP.

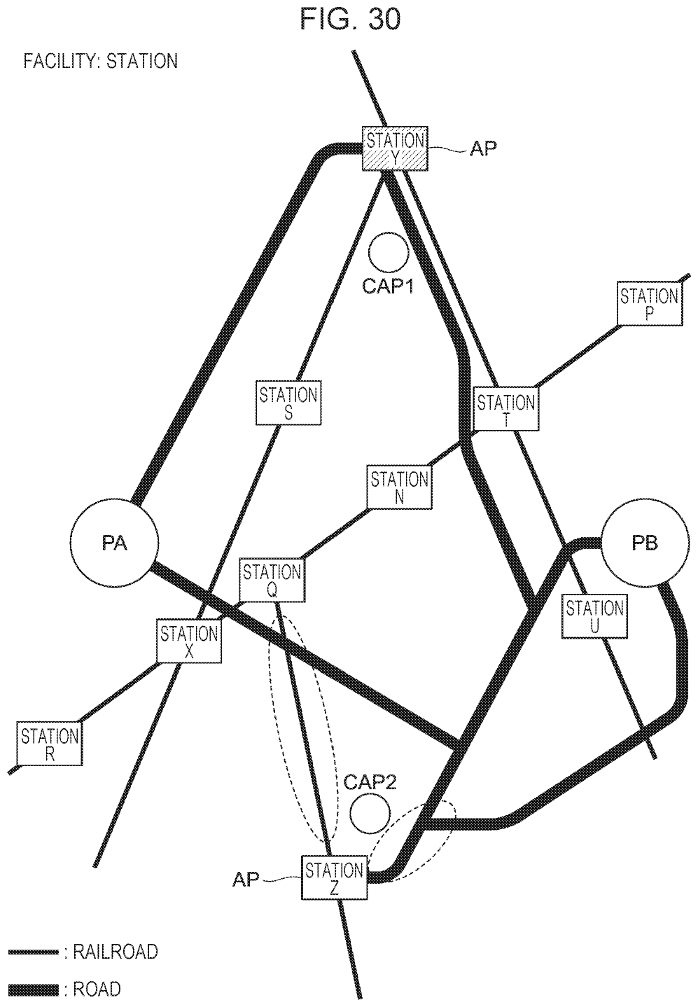

FIG. 30 explains a case where a place that allows for a shorter distance of path overlap with another target person is determined to be the appointment place AP. FIG. 30 uses the same or corresponding reference signs to refer to features corresponding to those in FIG. 29.

In FIG. 30 as well, there are two persons, AA and BB, who arrange to meet. Thus, there are two reference points, the place PA and the place PB. In the case of FIG. 30 as well, there are two candidate appointment places, CAP1 and CAP2. In the case of FIG. 30 as well, train stations are designated as an example of a facility. Thus, one of the station Y and the station Z, which are respectively located in the vicinity of the candidate appointment places CAP1 and CAP2, is determined to be the appointment place AP.

In the case of FIG. 30, no overlap is observed between a path using a road going from the station Y to the place PA, and a path using a road going from the station Y to the place PB. No overlap is observed also for the corresponding paths using railroads.

By contrast, an overlap is observed between a path using a road going from the station Z to the place PA, and a path using a road going from the station Z to the place PB, at least for the area bounded by dashed lines. For the corresponding paths using railroads, an overlap is observed for the section between the station Z and the station Q.

Accordingly, the station Y, which allows for the less path overlap between AA and BB on their way home, is determined to be the appointment place AP. The shorter the path overlap, the closer the point at which one parts ways with the other person is to the appointment place AP, in other words, the farther such a point is from the one's reference point, and thus the less likely the reference point is to be found out by the other person.

It is to be noted, however, that route overlap may be determined with each of the reference places PA and PB taken as a starting point. This is because routes available on the way to a meeting place may differ from routes available on the way back.

In determining route overlap, even if a single member has designated plural reference places, route overlap may be determined only with respect to the member's home. This is because, conceivably, one's home has higher priority than other places as a reference point that one does not want the other person to know. Further, this narrows the number of reference points used in determining route overlap to one, thus allowing for reduced computational load. It is to be noted, however, that each member may be allowed to choose which reference point is to be used in determining route overlap.

(4) Although the cloud system 1 described above with reference to the exemplary embodiments is assumed to be used for a membership-based service, the cloud system 1 may not necessarily be used for a membership-based service. In one example, the cloud system 1 may be used by employees or other such persons. In another example, the cloud system 1 may be used for a meeting to be arranged between acquaintances or family members. In another example, it is also possible to use the cloud system 1 for cases where each person wants to determine a place to meet at without having his or her current location known. In this case, the current location is designated as a reference point.

(5) Although the exemplary embodiments above assume a situation where a male member and a female member who arrange to meet are presented with a place to meet at, the persons who arrange to meet may be persons of the same gender. For example, the cloud system 1 may be used for a meeting to be arranged between persons of the same gender with common interests or hobbies or a common purpose. Of course, the cloud system 1 may be used for a meeting to be arranged between acquaintances.

(6) In the exemplary embodiments above, every time a person decides with whom to arrange a meeting (see, for example, FIGS. 3A and 3B), the person is presented with a screen prompting for entry of information such as a reference point and a distance used in determining a meeting place (see, for example, FIGS. 6A and 6B and FIGS. 8A and 8B). In another alternative configuration, for one or both of these pieces of information, the corresponding screen may not be presented. For cases where a screen prompting for entry of such information is not presented, for example, the place or distance last used, or a preset place or distance is used. It is to be noted, however, that in this case as well, a screen for checking the reference point or the distance to be used in determining a meeting place may be displayed.

(7) In the exemplary embodiments above, the processor 21 (see FIG. 1) of the cloud server 20 (see FIG. 1) provides the service of determining a meeting place and presenting the determined meeting place to each target person, the information processing apparatus used to provide this service is not limited to the cloud server 20. For example, the information processing apparatus may be an on-premise server. Likewise, the network that connects the information processing apparatus that provides the service with the terminals 31 and 32 is not limited to the cloud network 10. For example, the network may be a local area network. The information processing apparatus may not necessarily be implemented as a server.

(8) In the embodiments above, the term “CPU” refers to a processor in a broad sense. Examples of the processor include general processors (e.g., CPU: Central Processing Unit) and dedicated processors (e.g., GPU: Graphics Processing Unit, ASIC: Application-Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information presentation method executed by a processor of an information processing apparatus, the information processing apparatus providing a service, the service presenting a plurality of target persons who satisfy a criterion with a meeting place to meet at, the information presentation method comprising:
acquiring information, the information being related to a plurality of reference points designated by the plurality of target persons;
determining a meeting place from at least one location, the at least one location being a location whose distances from the plurality of reference points designated by the plurality of target persons are all greater than or equal to corresponding predetermined thresholds; and
presenting the determined meeting place to each target person.

2. The information presentation method according to claim 1, further comprising
presenting a first screen to each target person, the first screen prompting the target person to enter a reference point.

3. The information presentation method according to claim 2, further comprising
accepting designation of a plurality of reference points through the first screen.

4. The information presentation method according to claim 1, further comprising
presenting a second screen to each target person, the second screen accepting designation of a threshold.

5. The information presentation method according to claim 2, further comprising
presenting a second screen to each target person, the second screen accepting designation of a threshold.

6. The information presentation method according to claim 4, further comprising
presenting the second screen to each target person.

7. The information presentation method according to claim 4, further comprising,
if each one target person designates a plurality of reference points, presenting the second screen for each reference point.

8. The information presentation method according to claim 4, further comprising
presenting a threshold candidate on the second screen.

9. The information presentation method according to claim 8, further comprising
changing, in accordance with a regional characteristic, a threshold candidate presented to each target person, the regional characteristic being a characteristic of a geographical region where the service is provided.

10. The information presentation method according to claim 9,
wherein the regional characteristic comprises one of a population of the geographic region and a population density of the geographical region.

11. The information presentation method according to claim 9,
wherein the regional characteristic comprises a station-to-station distance in the geographic region.

12. The information presentation method according to claim 1, further comprising,
if a specific target person makes a setting of not considering how far a meeting place is from a reference point, determining a meeting place from at least one location, the at least one location being a location whose distances from a plurality of reference points designated by a plurality of other target persons excluding the specific target person are all greater than or equal to corresponding predetermined thresholds.

13. The information presentation method according to claim 12, further comprising
presenting a third screen to each target person, the third screen accepting the setting of not considering how far a meeting place is from a reference point.

14. The information presentation method according to claim 1, further comprising
determining a location to be a meeting place, the location being a location for which a number of routes available for traveling between the location and a reference point is greater than a number of locations for another location.

15. The information presentation method according to claim 14, further comprising
counting the number of routes with the meeting place as a starting point.

16. The information presentation method according to claim 1, further comprising
determining a location to be a meeting place, the location being a location with a shorter distance of route overlap with another target person than another location.

17. The information presentation method according to claim 1, further comprising
determining a meeting place based on information related to a facility previously designated by each target person.

18. The information presentation method according to claim 1, further comprising,
if the plurality of reference points designated by the plurality of target persons are placed on a map and connected by a plurality of line segments, determining a meeting place from two locations, the two locations including a location lying on an edge of a polygon and a location outside the polygon, the polygon being formed by connecting a plurality of outermost line segments of the plurality of line segments.

19. An information processing apparatus comprising a processor, the processor being configured to
acquire information, the information being related to a plurality of reference points designated by a plurality of target persons, the plurality of target persons being a plurality of users of a service who satisfy a criterion, the service presenting a meeting place for the plurality of target persons to meet at,
determine a meeting place from at least one location, the at least one location being a location whose distances from the plurality of reference points designated by the plurality of target persons are all greater than or equal to corresponding predetermined thresholds, and
present the determined meeting place to each target person.

20. A non-transitory computer readable medium storing a program causing a computer to execute a process, the process comprising:
acquiring information, the information being related to a plurality of reference points designated by a plurality of target persons, the plurality of target persons being a plurality of users of a service who satisfy a criterion, the service presenting a meeting place for the plurality of target persons to meet at,
determining a meeting place from at least one location, the at least one location being a location whose distances from the plurality of reference points designated by the plurality of target persons are all greater than or equal to corresponding predetermined thresholds; and
presenting the determined meeting place to each target person.
